(19) United States
(12) Patent Application Publication
(10) Pub. No.: US 2021/0405654 A1
(43) Pub. Date: Dec. 30, 2021

(54) AUTONOMOUS TAKING OFF, POSITIONING AND LANDING OF UNMANNED AERIAL VEHICLES (UAV) ON A MOBILE PLATFORM

(71) Applicant: INFINIUM ROBOTICS PTE LTD, Singapore (SG)

(72) Inventors: Soner ULUN, Singapore (SG); Dogan KIRCALI, Singapore (SG); Junyang WOON, Singapore (SG)

(73) Assignee: INFINIUM ROBOTICS PTE LTD, Singapore (SG)

(21) Appl. No.: 17/029,020

(22) PCT Filed: Mar. 22, 2019
(86) PCT No.: PCT/SG2019/050161

§ 371 Date: Sep. 22, 2020

(30) Foreign Application Priority Data
Mar. 22, 2018 (SG) 10201802386T
Nov. 21, 2018 (SG) 10201810386U

(51) Int. Cl. G05D 1/06; G05D 1/10; G06K 9/00; G06K 9/46; G06K 9/62; G06T 7/80; G06T 7/70; B64C 39/02

(52) U.S. Cl. CPC G05D 1/0653; G05D 1/101; G06K 9/0063; G06K 9/4661; G06K 9/6289; B64C 2201/141; G06T 7/70; B64C 39/024; G06T 2207/30204; G06T 2207/30244; B64C 2201/127; G06T 7/80

(57) ABSTRACT

A method for autonomously tracking a landing surface by a UAV to enable repeated autonomous take off and landings without the need for GPS data or any other satellite positioning techniques. The landing surface may be on an autonomous and/or moving ground vehicle, and comprises two or more markers on the landing surface. The markers may be of different sizes. The drone comprises two or more downward looking cameras, with at least one camera having a different focal length to the other, to form a dual monocular system which captures images of the markers on the landing surface. The images are analysed to estimate the pose of the markers and thus determine the location of the UAV with respect to the landing surface, which is then provided to a flight controller of the UAV.

### PRIORITY DOCUMENTS

The present application claims priority from Singaporean Provisional Patent Application No. 10201802386T titled “Autonomous Taking off, Positioning and Landing of UAV on a mobile platform” and filed on 22 Mar. 2018, the content of which is hereby incorporated by reference in its entirety.

### TECHNICAL FIELD

The present disclosure relates to Unmanned Aerial Vehicle (UAV). In a particular form the present disclosure relates to autonomous landing systems for UAV.

### BACKGROUND

There are many works concentrated on the landing of an Unmanned Aerial Vehicle (UAV) on a stationary object or landing pads, but the related work for landing on an Autonomous Ground Vehicle (AGV) or any mobile platforms is quite limited in number as the complexity of such a system is considerably larger than a single robotics system. In such systems the UAV needs to autonomously take off and land back on the landing platform for re-fuel or for maintenance, before taking off for the next mission. Examples of such applications include border and security surveillance, agriculture, mining and stockpiling for outdoor applications. There also exist many situations where the UAV must operate indoors, or in poor-UPS, or UPS-denied environments. Such applications include stocktaking of warehouse inventory, indoor facility inspections, shipping tank inspections or any other GPS-denied applications. In such systems the AGV may move, and thus it is desirable that the UAV is able to repeatedly and accurately take off, track the location of the AGV, and then land back on the AGV.

There is thus a need to provide autonomous tracking methods and systems for UAVs, or to at least provide a useful alternative to existing systems.

### SUMMARY

According to a first aspect, there is provided a method for tracking the location of a first reference point of a landing surface by an unmanned aerial vehicle (UAV) comprising at least two cameras and a flight controller comprising at least one inertial measurement unit (IMU), wherein the landing surface comprises at least two markers, the method comprising:

during a calibration phase:

storing at least one geometrical property of each of the at least two markers;

capturing at least a first calibration image containing a least a first marker by a first camera, and capturing at least a second calibration image containing at least a second marker by a second camera wherein each of the cameras has a different focal length; and

estimating the pose of each marker with respect to the first reference point is performed using at least one estimated geometrical property of the marker and the stored at least one geometrical property of the marker; and

obtaining a pose of each camera with respect to a second reference point on the UAV;

storing calibration data comprising at least the pose of each of the at least two markers with respect to the first reference point and a pose of each camera with respect to a second reference point on the UAV;

and during a flight phase:

capturing at least one image containing at least one of the markers by at least one camera;

generating one or more pose estimates for each of the at least one camera comprising:
for each captured image and for at least one of the markers in the captured image, estimating a pose of the camera that captured the image with respect to one of the at least one markers in the image using an estimate of at least one geometrical property of the respective marker in the captured image and the stored at least one geometrical property of the respective marker;

estimating the pose of the UAV with respect to the first reference point by fusing the one or more pose estimates for each of the at least one camera using the calibration data;

providing the estimate of the pose of the UAV as input to the flight controller of the UAV for tracking the location of the first reference point.

In one embodiment, at least one marker has a larger size than at least one other marker. In one embodiment, fusing comprises averaging the at least a first pose estimate and the at least a second pose estimate. In one embodiment fusing comprises selecting one of the at least a first pose estimate or the at least a second pose estimate.

In one embodiment, during the calibration phase, the capturing step is performed when the UAV is landed on the landing surface, and during a take-off portion or a landing portion of the flight phase capturing at least one image comprises capturing at least a first image containing the first marker by the first camera and at least a second image containing at least the second marker by the second camera in a first height range, and generating one or more pose estimates for each of the at least one camera comprises generating at least a first pose estimate of the first camera with respect to the first marker and at least a second pose estimate of the second camera with respect to the second marker.

In one embodiment, the second camera has a longer focal length than the first camera, and a size of the first marker in the first calibration image is less than the smaller of a width dimension and a height dimension of the first calibration image, and a size of the second marker is at least equal to or larger than the size of the first marker.

In one embodiment, during the calibration phase a first set of two or more calibration images each containing the first marker are captured by the first camera, and a second set of two or more calibration images each containing the second marker are captured by the second, and the step of estimating at least a first pose of the first camera comprises estimating a first set of poses, wherein each pose in the first set is estimated from the corresponding image in the first set of two or more calibration images, and averaging the poses in the first set to obtain the estimate of the pose of the first marker with respect to the reference point, and estimating a second set of poses, wherein each pose in the second set is estimated from the corresponding image in the second set of two or more calibration images, and averaging the poses in the second set to obtain the estimate of the pose of the second marker with respect to the reference point.

In one embodiment, if estimation of at least a first pose of the first camera with respect to the first marker fails, then fusing the first pose estimate of the first camera and the second pose estimate of the second camera comprises using the second pose estimate of the second camera to estimate the pose of the UAV with respect to the reference point

In one embodiment, the step of obtaining calibration data is performed in at least two calibration phases, wherein the first calibration phase is performed when the UAV is landed on the landing surface, and the second phase and any subsequent phase is performed when the UAV is at one or more locations away from the landing surface and second camera has a focal length such that when the UAV is landed on the landing surface at least the first marker is visible to the first camera, and the two or more makers are not required to be visible to the other cameras, and the step of capturing at least a first calibration image containing a least a first marker by a first camera, and capturing at least a second calibration image containing at least a second marker by second camera is performed as part of the second calibration phase, and wherein

the first calibration phase comprises:

capturing at least a first calibration image containing the first marker by the first camera; and

estimating the pose of the first marker with respect to the first reference point using at least one estimated geometrical property of the first marker and the stored at least one geometrical property of the first marker; and

obtaining a pose of the first camera with respect to the second reference point;

and the second calibration phase and any subsequent calibration phase comprises:

capturing, by a pair of cameras, at least a first image by one of the cameras containing at least two markers, and at least a second image captured by the other camera in the pair containing at least one of the at least two markers in the first image,

wherein each subsequent phase comprises repeating the capturing step with a new pair of cameras and is performed if there is insufficient images captured to enable a pose estimate of each marker with respect to the first reference point to be estimated and to enable a pose estimate of each camera with respect to second reference point to be estimated, and the UAV may be moved between each phase;

estimating, for each marker other than the first marker, the pose of the marker with respect to the reference point using at least one estimated geometrical property of the marker and the stored at least one geometrical property of the marker; and

estimating, for each camera other than the first camera, a pose of the camera with respect to the second reference point wherein the estimate is performed indirectly by estimating the pose of the camera with respect to the first camera.

In one embodiment, during the flight phase, generating one or more pose estimates for each of the at least one camera further comprises estimating a camera-marker weight for each marker captured in an image by a camera, and fusing comprises calculating a weighted sum of the one or more pose estimates using the associated camera-marker weights to obtain an estimate of the pose of the UAV with respect to the first reference point.

In one embodiment, a camera-marker weight is based on a size of the marker in the image.

In one embodiment, a camera-marker weight is calculated using a continuous or non-continuous function.

In one embodiment, the two or more markers are formed of a reflective surface, and the UAV illuminates the landing surface. In one embodiment, each marker is a rectangle or a square and estimating the pose of a marker comprises identifying four corners of the marker, and the position of a marker in a plane containing landing surface is calculated from the four detected corners using homographic estimation.

In one embodiment, the geometrical property is a perimeter of the marker.

In one embodiment, the calibration data further comprises one or more transformation matrices for transforming a measurement obtained from an image from a UAV coordinate frame centred on the second reference point to a global coordinate frame centred on the first reference point.

According to a second aspect, there is provided an unmanned aerial vehicle (UAV) comprising:

at least two cameras, wherein each camera has a downward field of view with respect to the UAV and wherein at least the second camera has a different focal length to the first camera;

a flight controller comprising at least one inertial measurement unit (IMU);

at least one processor and a memory, the memory comprising instructions to perform the method of the first aspect.

According to a third aspect, there is provided a system comprising an unmanned aerial vehicle (UAV) according to the second aspect and moveable vehicle comprising a landing surface for the UAV.

According to a fourth aspect, there is provided an unmanned aerial vehicle (UAV) comprising:

at least two cameras, wherein each camera has a downward field of view with respect to the UAV and wherein at least the second camera has a different focal length to the first camera;

a flight controller comprising at least one inertial measurement unit (IMU);

at least one processor and a memory, the memory comprising instructions to tracking the location of a first reference point of a landing surface, wherein the landing surface comprises at least two markers, wherein during a calibration phase the processor is configured to:
store at least one geometrical property of each of the at least two markers;
capture at least a first calibration image containing a least a first marker by a first camera, and capturing at least a second calibration image containing at least a second marker by a second camera; and
estimate the pose of each marker and with respect to the first reference point on the landing surface using at least one estimated geometrical property of each marker and the stored at least one geometrical property of the marker;
obtain, either directly or indirectly, a pose of each camera with respect to a second reference point on the UAV;
store calibration data comprising at least the pose of each of the at least two markers with respect to the first reference point and a pose of each camera with respect to a second reference point on the UAV;
   and during a flight phase the processor is configured to:

capture at least one image containing at least one of the markers by at least one camera;

generating one or more pose estimates for each of the at least one camera comprising:
for each captured image and for at least one of the markers in the captured image, estimating a pose of the camera that captured the image with respect to one of the at least one markers in the image using an estimate of at least one geometrical property of the respective marker in the captured image and the stored at least one geometrical property of the respective marker;

estimate the pose of the UAV with respect to the first reference point by fusing the one or more pose estimates for each of the at least one camera using the calibration data;

provide the estimate of the pose of the UAV as input to the flight controller of the UAV for tracking the location of the first reference point.

### BRIEF DESCRIPTION OF DRAWINGS

Embodiments of the present disclosure will be discussed with reference to the accompanying drawings wherein:

FIG. 1A is a flowchart of a method for tracking the location of a landing surface according to an embodiment;

FIG. 1B is a flowchart of a calibration phase of a method for tracking the location of a landing surface according to an embodiment;

FIG. 1C is a flowchart of a flight phase of a method for tracking the location of a landing surface according to an embodiment;

FIG. 2 is an illustration of the first two elements of three marker families according to an embodiment;

FIG. 3A is an illustration of the reference coordinate frame defined by normal vectors centered on the first reference point on the UGV in which the landing surface defines the xy plane and according to an embodiment;

FIG. 3B is an illustration of the reference coordinate frame defined by normal vectors centered on the first reference point on the UGV in which the landing surface defines the xy plane during a first calibration phase according to another embodiment;

FIG. 3C is an illustration of the reference coordinate frame defined by normal vectors centered on the first reference point on the UGV in which the landing surface defines the xy plane during a second calibration phase according to another embodiment;

FIG. 4 is a view from each camera in the UAV in its landed state during a calibration phase according to an embodiment;

FIG. 5 is a schematic diagram of the known, observed and generated/estimated transformations between the UGV coordinate frame and UAV coordinate frame according to an embodiment;

FIG. 6 is another schematic diagram of the known, observed and generated/estimated transformations between the UGV coordinate frame and UAV coordinate frame according to an embodiment;

FIG. 7 is a schematic block diagram of the control architecture 70 of a UAV according to an embodiment;

FIG. 8 is a flowchart of a landing process according to an embodiment;

FIG. 9A shows a side profile of a UAV according to an embodiment;

FIG. 9B shows a bottom profile of the UAV of FIG. 9A; and

FIG. 9C is a perspective view of an embodiment of a UAV landed on a UGV;

FIG. 10A is a panel of plots of a flight test using a first embodiment;

FIG. 10B is a panel of plots of a range test using a first embodiment;

FIG. 10C is a panel of plots of a flight test using a second embodiment; and

FIG. 10D is a panel of plots of a range test using a second embodiment.

In the following description, like reference characters designate like or corresponding parts throughout the figures.

### DESCRIPTION OF EMBODIMENTS

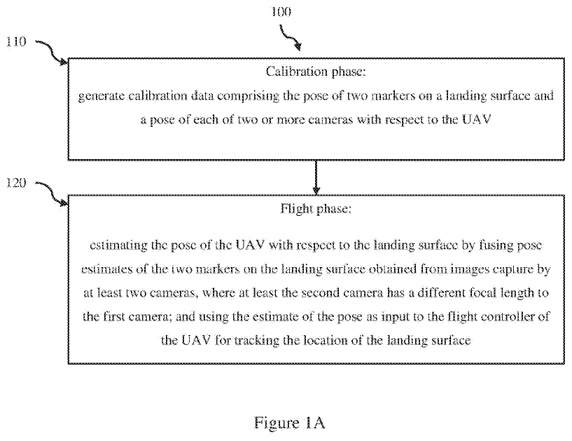

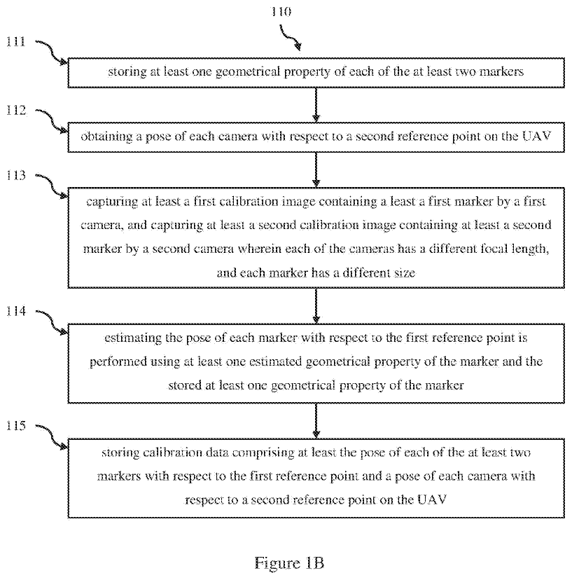

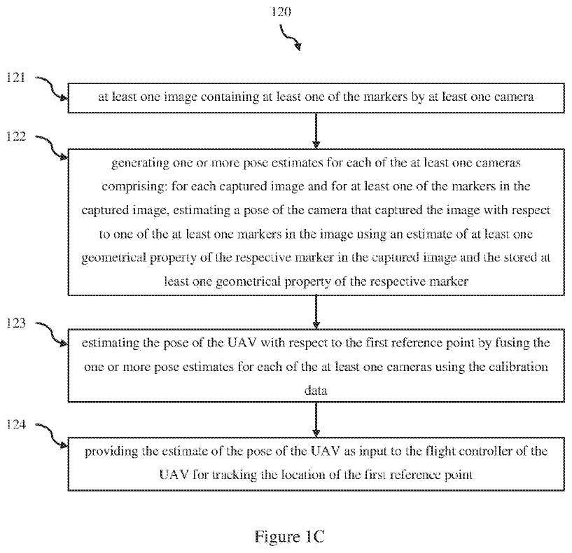

Referring now to FIG. 1A, there is shown a flowchart of a method 100 for tracking the location of a landing surface by a UAV according to an embodiment. In this embodiment the method 100 comprises a calibration phase 110 and a flight phase 120. The landing surface comprises at least two markers, and the UAV comprises at least a downward facing dual monocular camera system in which the second camera has a different focal length to the first camera and each is used to capture images of the one or more markers on the landing surface. The UAV may have more than two cameras in which case at least one of the cameras has a different focal length and field of view to at least one other camera. The camera with the shortest focal length is arbitrarily labelled the first camera, and the camera with the next longer focal length is arbitrarily labelled the second camera. In the case of three cameras, two of the cameras could have the same focal length, and the other camera having a different focal length (either smaller or larger), or all three could have different focal lengths, with the camera with the longer focal length arbitrarily labelled the third camera. In the calibration phrase, calibration data comprising the pose of two markers on a landing surface and a pose of each of the cameras with respect to the UAV. In some embodiment the markers are pre-generated fiducial markers and are each of different sizes. During the flight phase 120 the pose of the UAV is estimated with respect to the landing surface by fusing pose estimates of the two markers on the landing surface obtained from images capture by the cameras. The pose of the UAV is used as input to the flight controller of the UAV for tracking the location of the landing surface. In one embodiment the flight controller includes at least one inertial measurement unit (IMU). The landing surface may be located on a moveable vehicle, including autonomous vehicles (eg a UGV, unmanned boat) and other moving vehicles such as car, trucks, boats, etc.

In the context of the specification the pose of an object refers to the combination of position and orientation of the object. This will typically be an (x, y, z) position and angular orientation (ϕ, θ, ψ) in a reference coordinate system. In one embodiment we define a first reference point on the landing surface, and define the coordinate system so that it is a centered on the a first reference point and the landing surface is within the x-y plane. We can also define a second reference point on the UAV, and pose estimates of the UAV are defined in relation to this second reference point.

FIG. 1B is a flowchart of a calibration phase 110 of the method 100 for tracking the location of a landing surface shown in FIG. 1A according to an embodiment. The method comprises storing at least one geometrical property of each of the at least two markers 111. The geometrical properties may be a size, a perimeter, a shape, or some other property that can be estimated in or from an image of the marker. At step 112 a pose of each camera with respect to the second reference point on the UAV is obtained. This can be obtained from direct measurements, a 3D model of the UAV. In some embodiments only a first pose of the camera is measured, and the poses of the remaining cameras are obtained by estimation during the calibration phrase. The pose of each camera with respect to the second reference point may be obtained directly or indirectly. For example the pose of the rust camera to the second reference could be obtained, and then the pose of each other camera to the first camera obtained. The pose of each other camera to the second reference point can thus be obtained in a two-step process by combining the pose of the other camera to the first camera and the pose of the first camera to the second reference point. In embodiments where the pose is represented as a transformation matrix to facilitate such calculations. At step 113 the first camera is used to capture at least a first calibration image containing a least a first marker, and the second camera captures at least a second calibration image containing at least a second marker. As noted above each of the cameras has a different focal length, and in some embodiments at least one marker has a different size to the other markers. The images are then used in step 114 which comprises estimating the pose of each marker with respect to the first reference point. This estimate is performed using at least one estimated geometrical property of the marker (from an image) and the stored (ie known) geometrical property of the marker. In some embodiments the markers are rectangular markers and estimating the pose of a marker comprises identifying the four corners of the marker, and the is calculated from the four detected corners using homographic estimation. In some embodiments the geometrical property is the perimeter, which is obtained from identifying the four corners. At step 114, the calibration data is stored. This calibration data comprises at least the pose of each of the at least two markers with respect to the first reference point and a pose of each camera with respect to the second reference point on the UAV. As will be discussed below, in some embodiments this calibration data takes the form of transformation matrices used to transform a measurement in the UAV/camera coordinate system to the UGV coordinate system. Thus in the discussion below, references to transformation matrices will be understood form part of the calibration data, representing a convenient form to store calibration data such as the pose of each marker, or the pose of a camera with respect to a reference point on the UAV.

FIG. 1C is a flowchart of a flight phase 120 of the method 100 for tracking the location of a landing surface shown in FIG. 1A according to an embodiment. At step 121, the UAV captures at least one image containing at least one of the markers by at least one camera. During the flight phase (including take off and landing) this will happen repeatedly and images are analysed in real time to allow the UAV to track the landing surface. At step 122 the UAV generating one or more pose estimates for each of the at least one cameras. This comprises, for each captured image and for at least one of the markers in the captured image, estimating a pose of the camera that captured the image with respect to one of the at least one markers in the image using an estimate of at least one geometrical property of the respective marker in the captured image and the stored at least one geometrical properly of the respective marker. At step 123 the pose of the UAV (with respect to the first reference point) is estimating by fusing (or combining) the one or more pose estimates for each of the at least one cameras using the calibration data. The estimate of the pose of the UAV is then provided as input to the flight controller of the UAV for tracking the location of the first reference point 124.

Various embodiments of the system will now be described in greater detail. During flight at least one the markers is visible by at least one camera. In one embodiment, when the UAV is landed, each camera is configured to capture a single marker. During take-off and landing, each camera tracks each marker, until the UAV reaches a height where the smaller marker is no longer detectable. This method provides high accuracy during take-off and landing. In another embodiment, the requirement for each camera to capture a single marker when landed is relaxed, and only a single marker needs to be in view of one of the cameras when landed. This allows the second camera to have a longer focal length than in the previous embodiment, allowing the UAV to ascend to a greater maximum height. During take-off and landing, the second marker (and any further markers) will then come into view of the cameras so that during the flight phase at least one captured image will include at least two markers, and each image from each of a pair of cameras contains at least one common marker. This second embodiment requires at least a two part calibration method. In the first phase, the pose of the first marker is obtained using one of the cameras, and the pose of this camera with respect to the second reference point on the UAV is determined. In the second phase, images are captured in which the first camera captures both markers, and the second camera captures at least the second marker so that the pose of the second marker can be estimates from the pose of the first marker. This also allows the pose of the second camera to be estimated relative to the second reference point. More generally the second phase is repeated (m−1)(n−1) times where m is the number of cameras, and n is the number of markers, each phase comprises capturing, for each pair of markers in the at least two markers, at least a first calibration image containing the nth marker and the (n−1)th marker, by the mth camera, and capturing at least a second calibration image containing one or both of the nth marker and the (n−1)th marker by the (m−1)th camera.

As outlined above, the methods use two or more markers located on the landing surface. In some embodiments these are pre-generated fiducial markers. These markers can take any shape (eg square, rectangular, circular, elliptical, or even irregular), and are only required to have known geometrical properties so that homographic methods can be used to estimate pose or distance from a reference point based on analysis of marker in an image and the known geometrical property. The geometrical properties may be a perimeter, diameter, length of a side, radius, or a major/minor axis, area, shape, or some other property that can be estimated in or from an image of the marker. In some embodiments the markers may be formed of a reflective material, and the UAV may include an illumination source to assist in detecting the marker in an image. In some embodiments the markers are illuminated by a light source on the vehicle or landing surface. In some embodiments the markers are displayed using a display panel with an illumination source, such as LED panels. In most cases markers will not overlap. However in some embodiments the markers could be partially overlapping or a small marker could be embedded in a region of a larger marker. For example if a larger marker was a circular marker with an internal square object in known region of the circle (eg centre) with a known relative size to the diameter of the circle (eg square width=¼ diameter), the internal square marker could be formed as a second smaller square marker.

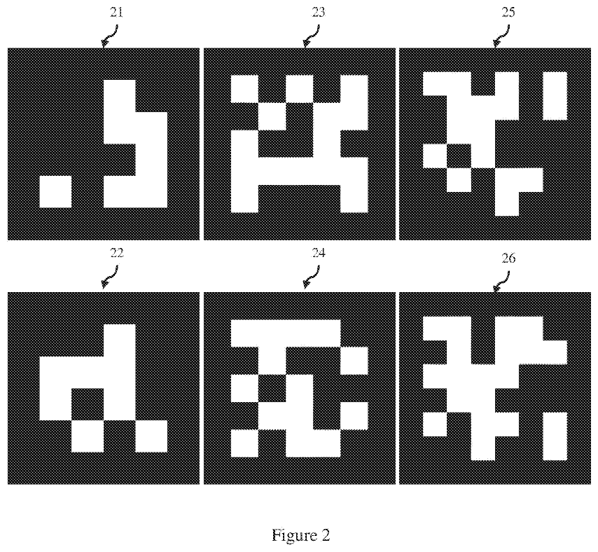

In some embodiments these markers are square-shaped with black and white colours, such as those initially designed for 3D graphics and augmented reality technologies but which have also used in robotic vision applications. A set of markers (or tags) may be grouped to form a marker family which have different bits sizes and Hamming distances from each other. A family can be described as Nhd where N is the bit size and while d is the Hamming distance between two markers. For example a family with N=25 bits of information and at least a minimum Hamming distance of d=9 is represented as the family 25h9. FIG. 2 shows the first two elements of families 16h5, 25h9 and 36h11. FIG. 2 shows the first and second elements in of each of marker families 16h5 (21, 22), 25h9 (23, 24) and 36h11 (25, 26) where the first element is in the first row, the second element is the second row, and each column is the same family.

Image analysis libraries, such as openCV and ROS, provide detector libraries which perform image analysis on image containing markers, and can calculate the pose of the marker relative to the camera, given the camera calibration matrix and the known size of the marker. The position of the marker is calculated from the four detected corners that are on a single plane using homography estimation. The accuracy of the calibration and the specifications of the vision system have a direct effect on the detection, and the detection range proportionally increases or decreases with the size of the marker. The number of bits on the marker affects the distance that can be detected. Markers with a larger number of bits have better coding performance and more family members, while markers with a smaller number of hits have better detection range. In theory a marker family with n=16 has 25% longer detection range compared to a family with n=36. Families with small n usually have a limited number of members in their family. If a family has a low minimum Hamming distance, the detection results show an increased ratio of false positives. In theory, a tag family with a small number of members has a slightly faster detection speed compared to a tag family with a large number of members as it needs to search through a shorter list of unique codes.

In one embodiment, the Apriltag, Apriltag2 and Aruco3 detector libraries were tested. All three of these detectors can calculate the pose of the marker relative to the camera, given the camera calibration matrix and the size of the marker. Aruco3 is selected over older versions of Aruco because it is considerably faster than its predecessors and enables to detect dictionaries from multiple tag generators. All detectors allow marker generation as well as expanding their dictionary of tag families. The online libraries available are used with minor modification such as including some missing functionalities for comparison purposes and including appropriate dictionaries when required. Aruco3 and Apriltag have ROS wrappers; as for Apriltag2, a wrapper following a similar style than Apriltag has been written. None of these wrappers provides or uses the perimeter information of a given marker, but this functionality is also added to those packages. Aruco3 and Apriltag2 libraries support multi-threading while Apriltag runs on a single core.

In a series of experiments, the minimum and maximum detection range were observed, as well as the minimum reliable perimeter and the average detection rates for each detector-family combination. In these experiments the markers had a size of 11 cm, and a high speed camera was used to capture images within an environment observed with an Optitrack system to provide ground truth data. Several datasets were collected and analysed. Greyscale image data was recorded at 85 Hz without using any compression and an image size of 800×600. A motion capture system (Optitrack) is used for the ground-truth and is captured at 180 Hz for four different bodies, one for the camera and three for each marker family. The ground-truth data and the images are saved to a high-speed SSD and post-processed for each tag detector-family combination. To record the maximum distance, the markers are moved along the z-axis of the camera to 7.5 m distance. The minimum distance is recorded for each tag family separately while the marker is as close as possible to the camera. The average detection rates and the maximum distance values are calculated. A single CPU core of an eight-core i7 processor was used for the post-processing with each detector and the results were analysed using Matlab.

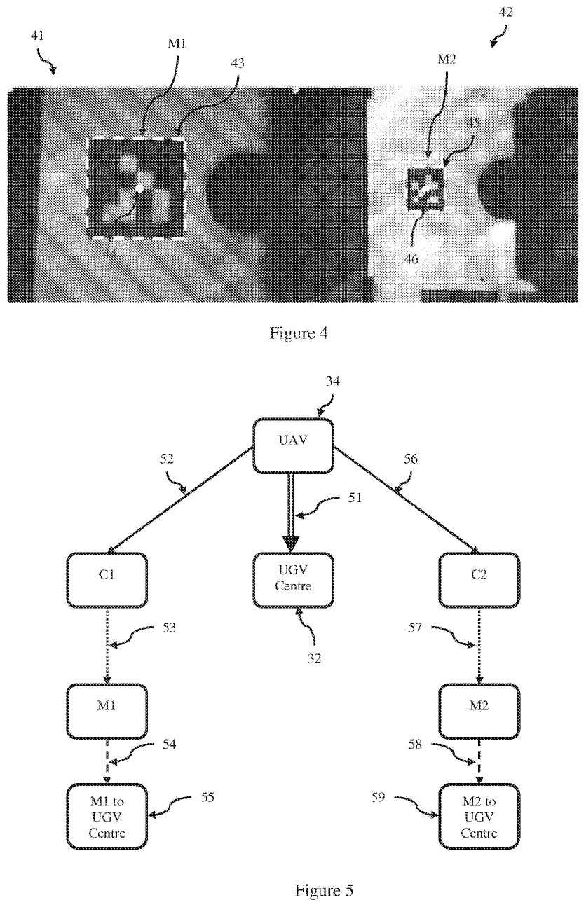

Table 1 presents the respective strengths and weaknesses of the three different detectors using 16h5, 25h9 and 36h11 families. It is better to compare the values in the table relatively towards each other rather than seen as an absolute performance, as the values are highly dependent on various variables such as focal length, image size, capture rate, lighting conditions and others. During these tests, Apriltag and Apriltag2 utilised 100% of the CPU while Aruco3 used between 55%-65%, meaning that it is possible to achieve higher detection rate with the Aruco3 detector. The 16h5 family has the most extended detection range for all detectors. The range difference between 25h9 and 36h11 families are 32.66%, 32.65% and 50.78%, respectively with Apriltag, Apriltag2 and Aruco3 detectors in the reliable detection range. The Aruco3 detector is the fastest while Apriltag2 has the most extended reliable detection range even though suffering from speed. The Apriltag2 detector shows a limited performance with several false positives as shown in the FIG. 4. The values inside the table show the data presented in the previous figures. Since Apriltag2 and 16h5 family-detector pair has no reliable area, these areas are left empty in the Table 1.

TABLE 1
Performance of detectors with different marker families

| | | Max | | Avg | Min |
|---|---|---|---|---|---|
| | Min | Reliable | Max | Detection | Reliable |
| Detector | Distance | Distance | Distance | Rate | Perimeter |
| Family | (m) | (m) | (m) | (det/s) | (pixel) |
| Apriltag - | 0.256 | 6.542 | 7.160 | 23.015 | 78.828 |
| 16h5 | | | | | |
| Apriltag - | 0.263 | 5.263 | 5.553 | 23.281 | 98.079 |
| 25h9 | | | | | |
| Apriltag - | 0.265 | 4.903 | 5.354 | 22.653 | 104.703 |
| 36h11 | | | | | |
| Apriltag2 - | 0.223 | N.A. | 6.959 | 11.054 | N.A |
| 16h5* | | | | | |
| Apriltag2 - | 0.213 | 5.582 | 6.160 | 11.156 | 93.642 |
| 25h9 | | | | | |
| Apriltag2 - | 0.218 | 5.246 | 5.764 | 11.306 | 98.604 |
| 36h11 | | | | | |
| Aruco3 - | 0.224 | 5.036 | 7.212 | 84.858 | 105.274 |
| 16h5 | | | | | |
| Aruco3 - | 0.230 | 4.424 | 6.755 | 84.394 | 118.591 |
| 25h9 | | | | | |
| Aruco3 - | 0.224 | 3.340 | 4.289 | 84.831 | 156.272 |
| 36h11 | | | | | |

The Apriltag detector with the 16h5 family was selected for the flight tests of the system. This decision is based on the several advantages of this detector. First, in many embodiments the system will be employed in a drone with limited processing power, and the Apriltag detector was more resilient against occlusions. The Apriltag2 is less suitable due to its poor real-time capabilities and high false detections rate. The Aruco3 detector is the fastest amongst all three, but the detections were noisier and thus require additional filtering. In one embodiment a perimeter checking system was added to the Apriltag ROS wrapper to exclude noisy position estimations. The position estimates are ignored if the marker perimeter size is smaller than a certain threshold which is decided empirically for each camera and lens combination.

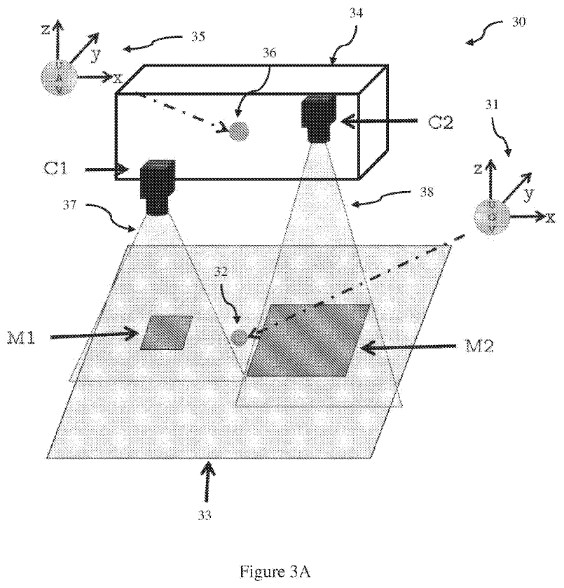

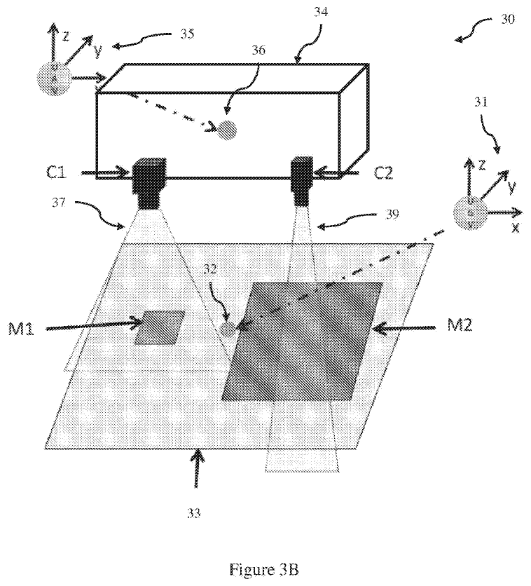

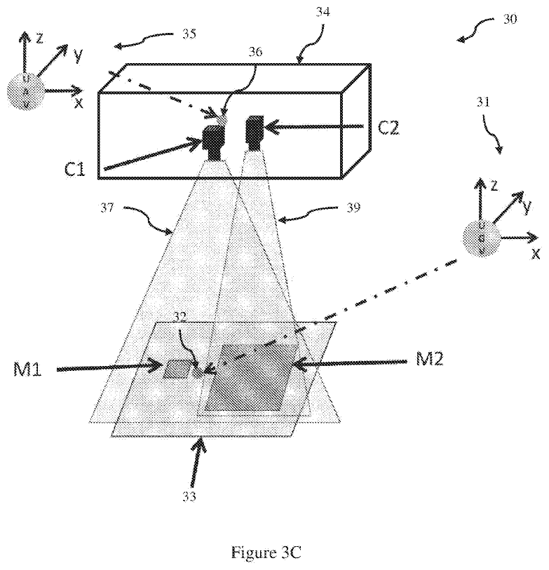

An embodiment of a calibration method and associated flight phase operation will now be described. FIG. 3A is an illustration of the reference coordinate frame 30 defined by normal vectors 31 centered on the first reference point 32 on the UGV. The landing surface 33 defines the xy plane and the reference coordinate frame will also be referred to as the UGV frame or the global reference frame. A UAV reference frame is also defined based on UAV normal vectors 35 centered on second reference point 36 located on the UAV 34. FIG. 3A shows the landing surface 33, the first camera C1 (also designated as C₁) and its associated field of view 37 which includes first marker M1 (also designated as M₁) and second camera C2 (also designated as C₂) and its associated field of view 38 which includes second marker M2 (also designated as M₁). The measurement from the camera frame to the marker frame is denoted with _{C}_{₁}^{M}^{₁}T_{L}, the subscript (.)_{L} notes that the drone is at landed state. _{C}_{₂}^{C}^{₁}T and _{M}_{₂}^{M}^{₁}T are used for physical constants which represent the transformation from the first to the second camera and from the first to the second marker respectively. All of the transformations are represented in the UGV frame 31, which is centered on the first reference point 32 while the second reference point 36 represents the centre of the UAV. The origin of the UGV frame is also the origin of the world frame. The orientation of the UAV frame, _{A}(.), with respect to the world frame, ^{G}(.) at k-th time frame is expressed with a rotation matrix in 1,

$${}_{A}^{W}{R}{}_{k}^{k} ( ϕ , θ , ψ ) = [ \begin{matrix}c ψ c θ & s ϕ s θ c ψ - c ϕ s ψ & c ϕ s θ c ψ + s ϕ s ψ \\ s ψ c θ & s ϕ s θ s ψ + c ϕ c ψ & c ϕ s θ s ψ - s ϕ c ψ \\ - s θ & s ϕ c θ & c ϕ c θ\end{matrix} ] \qquad ( 1 )$$

where c(.) and s(.) denote cos(.) and sin(.) respectively. The transformation matrix from the world frame to the UAV frame is shown as below:

$${}_{G}^{A}{T}{}_{k}^{k} = [ \begin{matrix}{}_{G}^{A}{R}{}_{k}^{k} & {}_{G}^{A}{t}{}_{k}^{k} \\ {0}_{1 \times 3} & 1\end{matrix} ] \qquad ( 2 )$$

where _{G}^{A}tₖ^{k} is the translation between the world and the UAV frames. When landed, the centre of the UAV frame is directly above the world frame at height h, _{G}^{A}t_{L}=[0 0 h]^{T}.

In this embodiment the system is composed of two cameras (on the UAV 34) and two markers on the landing surface 33. For the first calibrator, each marker can be observed at landed state with the nearest camera. The landing calibration is initiated when both the UAV and the UGV are stationary. Both cameras are calibrated, so the intrinsic values for each camera are known. The relative position of the cameras with respect to the centre of the UAV is known as well. The markers are placed on the planar surface, on the landing platform. The marker size and marker ids are known. Using these assumptions, the following relation between the cameras and marker frames at landed state can be written:

$${( {}_{{C}_{2}}^{{M}_{2}}{T}{}_{L}^{} )}^{- 1} \begin{matrix}{}_{{M}_{1}}^{{M}_{2}} T & {}_{{C}_{1}}^{{M}_{1}}{T}{}_{L}^{} & {}_{{C}_{2}}^{{C}_{1}} T \approx {I}_{4 \times 4}\end{matrix} \qquad ( 3 )$$

Equation (3) will hold if there is no measurement error and the physical system is the replica of the 3D model. In real life, there are always small errors. If three out of four elements in Equation (3) are known or can be measured, then we can compute the fourth element.

$${}_{{C}_{1}}^{{M}_{1}}{T}{}_{L}^{} {{}_{{C}_{2}}^{{C}_{1}} T ( {}_{{C}_{2}}^{{M}_{2}}{T}{}_{L}^{} )}^{- 1} \approx {}_{{M}_{2}}^{{M}_{1}} T = {}_{G}^{{M}_{1}} T {}_{{M}_{2}}^{G} T \qquad ( 4 )$$

The above equation can be written in the following way using other known transformations:

_{C}_{₁}^{M}^{₁}T_{L A}^{C}^{₁}T_{G}^{A}T_{L A}^{G}T_{L C}_{₂}^{A}T _{M}_{₂}^{C}^{₂}T_{L}≈_{G}^{M}^{₁}T _{M}_{₂}^{G}T

_{C}_{₁}^{M}^{₁}T_{L A}^{C}^{₁}T_{G}^{A}T_{L}≈_{G}^{M}^{₁}T

_{A}^{G}T_{L C}_{₂}^{A}T _{M}_{₂}^{C}^{₂}T_{L}≈_{M}_{₂}^{G}T (5)

As observed in Equation 5, the relation between each marker and the world frame can be calculated by using the measurements from each camera while the UAV is landed on the UGV.

The first calibration method starts by recording n_{C}_{₁}_{M}_{₁} and n_{C}_{₂}_{M}_{₂} measurements, then the average of the measurements is used to calculate the relative positions of the markers in the UGV frame. This helps to handle the imperfections inherent in the mounting of the cameras. The average may be an arithmetic mean, a robust average, a weighted average, etc. The view from each camera in the UAV in its landed state is shown in FIG. 4. It can be noted that the first image 41 from the first camera C1 on the left is slightly out of focus compared with the second image 42 from the second camera C2 on the right which is sharper. FIG. 4 also shows the outline of the estimated perimeter 43 of the first marker M1 and the estimated center of the first marker 44, along with the outline of the estimated perimeter 45 of the second marker M2 and the estimated center of the second marker 46. Table 2 shows an outline of the algorithm for performing a landing phase calibration according to an embodiment.

TABLE 2
First Algorithm for landing calibration

| Step | |
|---|---|
| 1 | $Initialize image capture , read yaml file for transformations , {}_{{C}_{1}}^{A} T {}_{A}^{G}{T}{}_{L}^{} , {}_{A}^{{C}_{2}} T$ |
| 2 | $procedure \text{:} Landing Calibration ( {}_{{C}_{1}}^{{M}_{1}}{T}{}_{L}^{} , {}_{{C}_{2}}^{{M}_{2}}{T}{}_{L}^{} ) \text{/} * Measurements from cameras * \text{/}$ |
| 3 | Wait for user confirmation till UAV is placed on desired landing position |
| 4 | while i ≤ n_{c}_{₁}ₘ_{₁} do |
| 5 | $if {}_{{C}_{1}}^{{M}_{1}}{T}{}_{L}^{} is available then \text{:}$ |
| 6 | ${X}_{6 \times i}^{{GM}_{1}} ← {}_{{C}_{1}}^{{M}_{1}}{T}{}_{L}^{}$ |
| 7 | end if |
| 8 | end while |
| 9 | ${\overline{X}}_{6 \times 1}^{G {M}_{1}} = \frac{1}{{n}_{{c}_{1} {m}_{1}}} {\sum }_{1}^{{n}_{{c}_{1} {m}_{1}}} {X}_{6 \times i}^{{GM}_{1}}$ |
| 10 | while j ≤ n_{c}_{₂}ₘ_{₂} do |
| 11 | $if {}_{{C}_{2}}^{{M}_{2}}{T}{}_{L}^{} is available then \text{:}$ |
| 12 | ${X}_{6 \times i}^{{GM}_{2}} ← {}_{{C}_{2}}^{{M}_{2}}{T}{}_{L}^{}$ |
| 13 | end if |
| 14 | end while |
| 15 | ${\overline{X}}_{6 \times 1}^{G {M}_{2}} = \frac{1}{{n}_{{c}_{2} {m}_{2}}} {\sum }_{1}^{{n}_{{c}_{2} {m}_{2}}} {X}_{6 \times i}^{{GM}_{2}}$ |
| 16 | end procedure |

The calibration algorithm starts with initiating the cameras. At each iteration, a check is run to determine if there is a new measurement. At each time a marker is observed, the position x, y, z and the orientation ϕ,θ,ψ (pose) information are extracted and stored in a 6×n sized matrix for each camera-marker pair after multiplying it with the known transformations shown in the Equation 5. Both n_{c}_{₁}ₘ_{₁} and n_{c}_{₂}ₘ_{₂} are equal to n for ease of notation.

$${X}_{6 \times n}^{{C}_{1} {M}_{1}} = [ \begin{matrix}{x}_{0} & {y}_{0} & {z}_{0} & {ϕ}_{0} & {θ}_{0} & {ψ}_{0} \\ ⋮ & ⋮ & ⋮ & ⋮ & ⋮ & ⋮ \\ {x}_{i} & {y}_{0} & {z}_{i} & {ϕ}_{i} & {θ}_{i} & {ψ}_{i} \\ ⋮ & ⋮ & ⋮ & ⋮ & ⋮ & ⋮ \\ {x}_{n} & {y}_{0} & {z}_{n} & {ϕ}_{n} & {θ}_{n} & {ψ}_{n}\end{matrix} ] \\ {X}_{6 \times n}^{{C}_{2} {M}_{2}} = [ \begin{matrix}{x}_{0} & {y}_{0} & {z}_{0} & {ϕ}_{0} & {θ}_{0} & {ψ}_{0} \\ ⋮ & ⋮ & ⋮ & ⋮ & ⋮ & ⋮ \\ {x}_{j} & {y}_{0} & {z}_{j} & {ϕ}_{j} & {θ}_{j} & {ψ}_{j} \\ ⋮ & ⋮ & ⋮ & ⋮ & ⋮ & ⋮ \\ {x}_{n} & {y}_{0} & {z}_{n} & {ϕ}_{n} & {θ}_{n} & {ψ}_{n}\end{matrix} ] \qquad ( 6 )$$

After the data collection is complete, the average position and orientation values are calculated for each marker with respect to the UGV centre as shown in the Equation 7 and Equation 8. The average may be an arithmetic mean, a robust average, a weighted average, etc. After this calibration data in the form of the transformations _{G}^{M}^{₁}T and _{G}^{M}^{₂}T are used as known constants for the marker connector algorithm (data fusion).

$$\begin{matrix}\begin{matrix}{}_{G}^{{M}_{1}} \overline{x} = \frac{1}{n} {\sum }_{i = 1}^{n} {X}_{6 \times i}^{{GM}_{1}} ( 1 ) & {}_{G}^{{M}_{1}} \overline{y} = \frac{1}{n} {\sum }_{i = 1}^{n} {X}_{6 \times i}^{{GM}_{1}} ( 2 ) & {}_{G}^{{M}_{1}} \overline{z} = \frac{1}{n} {\sum }_{i = 1}^{n} {X}_{6 \times i}^{{GM}_{1}} ( 3 ) \\ {}_{G}^{{M}_{1}} \overline{ϕ} = \frac{1}{n} {\sum }_{i = 1}^{n} {X}_{6 \times i}^{{GM}_{1}} ( 4 ) & {}_{G}^{{M}_{1}} \overline{θ} = \frac{1}{n} {\sum }_{i = 1}^{n} {X}_{6 \times i}^{{GM}_{1}} ( 5 ) & {}_{G}^{{M}_{1}} \overline{ψ} = \frac{1}{n} {\sum }_{i = 1}^{n} {X}_{6 \times i}^{{GM}_{1}} ( 6 )\end{matrix} & ( 7 ) \\ \begin{matrix}{}_{G}^{{M}_{2}} \overline{x} = \frac{1}{n} {\sum }_{j = 1}^{n} {X}_{6 \times j}^{{GM}_{2}} ( 1 ) & {}_{G}^{{M}_{2}} \overline{y} = \frac{1}{n} {\sum }_{j = 1}^{n} {X}_{6 \times j}^{{GM}_{2}} ( 2 ) & {}_{G}^{{M}_{2}} \overline{z} = \frac{1}{n} {\sum }_{j = 1}^{n} {X}_{6 \times j}^{{GM}_{2}} ( 3 ) \\ {}_{G}^{{M}_{2}} \overline{ϕ} = \frac{1}{n} {\sum }_{j = 1}^{n} {X}_{6 \times j}^{{GM}_{2}} ( 4 ) & {}_{G}^{{M}_{2}} \overline{θ} = \frac{1}{n} {\sum }_{j = 1}^{n} {X}_{6 \times j}^{{GM}_{2}} ( 5 ) & {}_{G}^{{M}_{2}} \overline{ψ} = \frac{1}{n} {\sum }_{j = 1}^{n} {X}_{6 \times j}^{{GM}_{2}} ( 6 )\end{matrix} & ( 8 )\end{matrix}$$

During the flight phase, a marker connector module is used for fusing the information from two different markers to continuously generate pose information as reference input for the UAV flight controller. Fusing comprises combining the data, such as by averaging, included weighted averaging. Fusing may also comprise assessing the quality or confidence of each estimate and choosing one of the two or more estimates available based on the estimate with the greatest confidence. After the calibration is completed, the position of the markers with respect to the UGV centre is known. Similarly to the calibration phase, the position of the cameras with respect to the UAV coordinate frame is known. Both markers can be observed at the landed state, and during the flight, at least one marker can be observed at all times. Both cameras have different focal length, and they are focused for different distances, one for far and one for near. The markers also have a different size. The camera C1 that is observing the small marker M1 has a shorter focal length while the camera C2 that is observing the large marker M2 has a longer focal length. In this embodiment the size of the small marker M1 is less than half of the height of the image, to ensure that during take-off and landing the marker is always in the image frame. On the other hand, the large marker is covering as much area as possible in the image frame, ensuring the most extended range possible.

FIG. 5 is a schematic diagram of the known, observed and generated/estimated transformations between the UGV coordinate frame and UAV coordinate frame. Solid lines 52, 56 are fixed known transformations, for example obtained from a 3D model of the UAV or directly measured. The dashed lines 54, 58 represent fixed transformations of the camera pose with respect to the UAV, and are obtained either by estimation as part of the landing calibration or are previously known values obtained by other means such as a from a 3D model or direct measurement. The dotted lines 52, 56 represent the measurements obtained by observing the markers M1 M2 from cameras C1 C2 respectively (ie observed transformations). The double black line 51 is the transformation computed by the marker connection module using fused information. Solid lines 52, 56, 54 and 58 represent fixed transformations while dotted lines 53, 57 and double lines 51 are changing during the flight.

The following function shows if the marker is observed by its respective camera:

$${}_{{C}_{i}}^{{M}_{i}}{O}{}_{k}^{} = \{ \begin{matrix}1 , & if marker is observed \\ 0 , & else\end{matrix} \qquad ( 9 )$$

where _{C}_{ᵢ}^{M}^{ᵢ}Oₖ is a scalar and represents if the i-th marker is observed with the i-th camera at the k-th time frame, where i can be either one or two (in this embodiment).

A 6×1 vector and a 4×4 transformation notation are used interchangeably. \vec{P}ₖ^{AM}^{₁}^{G} contains the same information of the combined transformation of:

_{A}^{G}Tₖ=_{M1}^{G}T _{A}^{M}^{₁}Tₖ (10)

which is the transformation from the UAV frame to the UGV centre through the first marker M1. The first three elements of this vector are for the translation x, y, z, and the last three are for the orientation ϕ, θ, ψ, measured between [−π, π]. Together these are the pose information.

$${\vec{P}}_{k}^{{AM}_{1} G} = [ \begin{matrix}{}_{A}^{{M}_{1}}{x}{}_{k}^{} & {}_{A}^{{M}_{1} G}{y}{}_{k}^{} & {}_{A}^{{M}_{1} G} z & {}_{A}^{{M}_{1} G}{ϕ}{}_{k}^{} & {}_{A}^{{M}_{1} G}{θ}{}_{k}^{} & {}_{A}^{{M}_{1} G}{ψ}{}_{k}^{}\end{matrix} ] \\ {\vec{P}}_{k}^{{AM}_{2} G} = [ \begin{matrix}{}_{A}^{{M}_{2}}{x}{}_{k}^{} & {}_{A}^{{M}_{2} G}{y}{}_{k}^{} & {}_{A}^{{M}_{2} G} z & {}_{A}^{{M}_{2} G}{ϕ}{}_{k}^{} & {}_{A}^{{M}_{2} G}{θ}{}_{k}^{} & {}_{A}^{{M}_{2} G}{ψ}{}_{k}^{}\end{matrix} ] \qquad ( 11 )$$

The two measurements are fused (averaged) using the following formula at any given time frame.

\vec{M}ₖ(i)=(_{C}_{₁}^{M}^{₁}Oₖ*\vec{P}ₖ^{AM}^{₁}^{G}(i)+_{C}_{₂}^{M}^{₂}Oₖ*\vec{P}ₖ^{AM}^{₂}^{G}(i))/2, i=1, . . . ,6 (12)

In this embodiment both markers have to be observable at landed state. Whilst this improves the robustness estimates of the pose of the UAV during take-off and landing, this does limit the focal length of the second camera, and thus the maximum height of the UAV. Secondly, as only two measurements are obtained at the region where the small marker starts to lose the detection, and in the end there is a single measurement, then there can lead to a discontinuity in the measurements. Lastly, it is known that there are small deviations and manufacturing errors in the physical setup. To eliminate these issues, in another embodiment the requirement that both cameras are detecting both markers is relaxed to allow only one camera to detect the marker while landed. Then, the information from all visible markers on the landing platform is used instead of a single marker for each camera. In this embodiment the system switches to the near camera during take-off and landing, switches to both cameras once sufficient height is obtained such that the second camera can see both markers, and switches to the far field camera at large heights. Further this system can be used with three or more cameras and/or three or more markers.

In this embodiment the notation for m camera and n markers is used. Similar to the previous embodiment, there are three assumptions. Firstly, it is assumed that one marker is detected at landed state. Secondly, at least one camera observes each marker pair at a given time. Lastly, it is assumed that each camera pair is observing at least one marker in common at a given time. During the image capture periods, both cameras and markers are stationary. The cameras are calibrated; the intrinsic values of the camera are known, the marker IDs and geometrical properties such as size, perimeter, shape etc are known (and stored). The relative position of the first camera that observes the first marker is known with respect to the centre of the UAV frame. The cameras are fixed on the drone, and the markers are fixed on a planar landing platform before the calibration process.

The calibration algorithm is described in Table 3, and it is composed of multiple phases depending on the number of cameras. Each phase comprises an image collection step where a pair of images from a pair of cameras is obtained where there are multiple markers in one image and a common marker in the two images. For two cameras there are two phases and for more than two cameras extra phases are performed until sufficient images have been collected so that all the required pose estimates can be calculated. The first phase is depicted in the FIG. 3B and is performed when the UAV is in the landed state on the landing surface 33 (of UGV), and the second phase is shown in the FIG. 3C in which the UAV is located a distance away from the UGV such that both cameras can view the first marker M1. FIG. 3B is a similar to FIG. 3A but illustrates the increase (change) in the field of view 39 of the second camera C2 during the first phase of calibration when the UAV is landed on the UGV. FIG. 3C is similar to FIG. 3B but showing the second calibration phase when both cameras can view the first marker M1.

TABLE 3
Second Algorithm for landing calibration

| Step | |
|---|---|
| 1 | $Initialize image capture , read yaml file for transformations , {}_{{C}_{1}}^{A} T {}_{A}^{G}{T}{}_{L}^{}$ |
| 2 | $procedure \text{:} Landing Calibration ( {}_{{C}_{1}}^{{M}_{1}}{T}{}_{L}^{} , {}_{{C}_{i - 1}}^{{M}_{j}}{T}{}_{k}^{} , {}_{{C}_{1}}^{{M}_{j - 1}}{T}{}_{k}^{} and , {}_{{C}_{i}}^{{M}_{j}}{T}{}_{k}^{} )$ |
| | /* Measurements from cameras */ |
| 3 | Wait for user confirmation till UAV is placed on desired landing position |
| 4 | while p ≤ nₚ do |
| 5 | $if {}_{{C}_{1}}^{{M}_{1}}{T}{}_{L}^{} is available then \text{:}$ |
| 6 | ${X}_{6 \times p}^{{GM}_{1}} ← {}_{{C}_{1}}^{{M}_{1}}{T}{}_{L}^{}$ |
| 7 | end if |
| 8 | end while |
| 9 | ${\overline{X}}_{6 \times 1}^{G {M}_{1}} = \frac{1}{{n}_{p}} {\sum }_{1}^{{n}_{p}} {X}_{6 \times p}^{{GM}_{1}}$ |
| 10 | for i=2:m do |
| 11 | for j=2:n do |
| 12 | Move the UAV to a position where: |
| 13 | Cam(i) can observe Marker(j) and Marker(j-1) |
| 14 | Cam(i-l) can observe Marker(j) or Marker(j-1) |
| 15 | Wait for user confirmation to initiation recording |
| 16 | Initialize. |
| 17 | while q ≤ n_{q} do |
| 18 | $if {}_{{C}_{i}}^{{M}_{j}}{T}{}_{k}^{} and {}_{{C}_{i}}^{{M}_{j - 1}}{T}{}_{k}^{} is available then$ |
| 19 | ${X}_{6 \times q}^{{GM}_{j}} ← {}_{{C}_{j}}^{{M}_{j - 1}}{T}{}_{k}^{}$ |
| 20 | end if |
| 21 | end while |
| 22 | ${\overline{X}}_{6 \times 1}^{G {M}_{j}} = \frac{1}{{n}_{q}} {\sum }_{1}^{{n}_{q}} {X}_{6 \times q}^{{M}_{j} {M}_{j - 1}}$ |
| 23 | end for |
| 24 | while r ≤ nᵣ do |
| 25 | $if {}_{{C}_{i}}^{{M}_{j}}{T}{}_{k}^{} and {}_{{C}_{i - 1}}^{{M}_{j}}{T}{}_{k}^{} is available then$ |
| 26 | ${X}_{6 \times r}^{A {C}_{i}} ← {}_{{C}_{i}}^{{C}_{i - 1}}{T}{}_{L}^{}$ |
| 27 | end if |
| 28 | end while |
| 29 | ${\overline{X}}_{6 \times 1}^{A {C}_{i}} = \frac{1}{{n}_{r}} {\sum }_{1}^{{n}_{r}} {X}_{6 \times r}^{A {C}_{i}}$ |
| 30 | end for |
| 31 | end procedure |

The second phase should be repeated with the rules described in the Algorithm in Table 3 for the cases where m>2 or n>2. The number of times it needs to be repeated depends upon the number of markers in each of the camera views and the number of cameras. Once sufficient information to allow the pose estimates to be performed is obtained the image capture can be stopped. The UAV may be moved between each phase (capturing step), for example to allow an image pair to be taken from a camera with a longer focal length. Depending upon how many markers each camera can observe there may be between 2 and (m−1)(n−1) phases where m is the number of cameras, and n is the number of markers. More phases can be conducted than is strictly necessary to collect extra data to allow averaging to be performed and/or to allow variability measures or confidence estimates to be obtained in the pose estimates. The system is formulated to enable landing calibration using the measurements from m cameras and compute the desired landing position for n markers even if they are not visible during take-off and landing. The case where m=n=2 is implemented, similar to the previous embodiment. The two differences in the hardware compared to the first embodiment are a longer focal length on the second camera C2 and an increased size of the large marker M2. As the first marker can be observed with the near camera, the following formula can be used, as in the previous embodiment:

$$\begin{matrix}\begin{matrix}{}_{{C}_{1}}^{{M}_{1}}{T}{}_{L}^{} & {}_{A}^{{C}_{1}} T & {}_{G}^{A}{T}{}_{L}^{} \approx {}_{G}^{{M}_{1}} T\end{matrix} & ( 13 ) \\ \begin{matrix}{}_{G}^{{M}_{1}} \overline{x} = \frac{1}{{n}_{p}} {\sum }_{i = 1}^{n} {X}_{6 \times i}^{{GM}_{1}} ( 1 ) & {}_{G}^{{M}_{1}} \overline{y} = \frac{1}{{n}_{p}} {\sum }_{i = 1}^{n} {X}_{6 \times i}^{{GM}_{1}} ( 2 ) & {}_{G}^{{M}_{1}} \overline{z} = \frac{1}{{n}_{p}} {\sum }_{i = 1}^{n} {X}_{6 \times i}^{{GM}_{1}} ( 3 ) \\ {}_{G}^{{M}_{1}} \overline{ϕ} = \frac{1}{{n}_{p}} {\sum }_{i = 1}^{n} {X}_{6 \times i}^{{GM}_{1}} ( 4 ) & {}_{G}^{{M}_{1}} \overline{θ} = \frac{1}{{n}_{p}} {\sum }_{i = 1}^{n} {X}_{6 \times i}^{{GM}_{1}} ( 5 ) & {}_{G}^{{M}_{1}} \overline{ψ} = \frac{1}{{n}_{p}} {\sum }_{i = 1}^{n} {X}_{6 \times i}^{{GM}_{1}} ( 6 )\end{matrix} & ( 14 )\end{matrix}$$

The calculated UGV centre also encodes the information of the preferred location to land. With this calculation, the first phase is completed. At the beginning of the second phase, the cameras are moved to a further position where the markers can be observed by both cameras. In one embodiment this can be done on the ground, by placing the UAV and surface on supports and orientating them so they are orthogonal to the ground. It starts with collecting the measurements of all markers observed from each camera. In the case that more markers are available which might give the same solution, it is preferred to use the markers with the larger perimeter.

The following equations can be observed:

_{C}_{₂}^{M}^{₁}T_{k M}_{₂}^{C}^{₂}Tₖ≈_{M}_{₂}^{M}^{₁}T

_{M}_{₁}^{G}Tₖ(_{M}_{₂}^{M}^{₁}T)⁻¹≈_{M}_{₂}^{G}T

_{M}_{₁}^{G}T_{k C}_{₂}^{M}^{₁}Tₖ(_{C}_{₂}^{M}^{₂}T)⁻¹≈_{M}_{₂}^{G}T (15)

The value of _{M}_{₁}^{G}T were computed in the Equation 14, the values of _{C}_{₂}^{M}^{₁}Tₖ and _{C}_{₂}^{M}^{₂}Tₖ are observed in a synchronised manner as they are calculated from the same image frame. To accurately compute _{M}_{₂}^{G}T, n_{q} measurements of the Equation 15 are stored in a matrix of 6×n_{q} elements and the average values of each element are calculated using the following formulas:

$$\begin{matrix}{X}_{6 \times {n}_{q}}^{{GM}_{2}} = [ \begin{matrix}{x}_{0} & {y}_{0} & {z}_{0} & {ϕ}_{0} & {θ}_{0} & {ψ}_{0} \\ ⋮ & ⋮ & ⋮ & ⋮ & ⋮ & ⋮ \\ {x}_{j} & {y}_{0} & {z}_{j} & {ϕ}_{j} & {θ}_{j} & {ψ}_{j} \\ ⋮ & ⋮ & ⋮ & ⋮ & ⋮ & ⋮ \\ {x}_{{n}_{q}} & {y}_{0} & {z}_{{n}_{q}} & {ϕ}_{{n}_{q}} & {θ}_{{n}_{q}} & {ψ}_{{n}_{q}}\end{matrix} ] & ( 16 ) \\ \begin{matrix}{}_{G}^{{M}_{2}} \overline{x} = \frac{1}{{n}_{q}} {\sum }_{i = 1}^{{n}_{q}} {X}_{6 \times i}^{{GM}_{2}} ( 1 ) & {}_{G}^{{M}_{2}} \overline{y} = \frac{1}{{n}_{q}} {\sum }_{i = 1}^{{n}_{q}} {X}_{6 \times i}^{{GM}_{2}} ( 2 ) & {}_{G}^{{M}_{2}} \overline{z} = \frac{1}{{n}_{q}} {\sum }_{i = 1}^{{n}_{q}} {X}_{6 \times i}^{{GM}_{2}} ( 3 )\end{matrix} & ( 17 ) \\ {}_{G}^{{M}_{2}} \overline{ϕ} = atan 2 ( {\sum }_{i = 1}^{{n}_{q}} sin ( {X}_{6 \times i}^{{GM}_{2}} ( 4 ) ) / {\sum }_{i = 1}^{{n}_{q}} cos ( {X}_{6 \times i}^{{GM}_{2}} ( 4 ) ) ) \\ {}_{G}^{{M}_{2}} \overline{θ} = atan 2 ( {\sum }_{i = 1}^{{n}_{q}} sin ( {X}_{6 \times i}^{{GM}_{2}} ( 5 ) ) / {\sum }_{i = 1}^{{n}_{q}} cos ( {X}_{6 \times i}^{{GM}_{2}} ( 5 ) ) ) \\ {}_{G}^{{M}_{2}} \overline{ψ} = atan 2 ( {\sum }_{i = 1}^{{n}_{q}} sin ( {X}_{6 \times i}^{{GM}_{2}} ( 6 ) ) / {\sum }_{i = 1}^{{n}_{q}} cos ( {X}_{6 \times i}^{{GM}_{2}} ( 6 ) ) ) & ( 18 )\end{matrix}$$

After the distances from each marker to the UGV centre are computed, it is necessary to compute the transformation from the UAV centre to the second camera, _{C}_{₂}^{A}T. As per the Equation 15, the following can be written:

(_{C}_{₁}^{M}^{₂}Tₖ)⁻¹ _{C}_{₂}^{M}^{₂}Tₖ≈_{C}_{₂}^{C}^{₁}T

_{C}_{₁}^{A}T _{C}_{₂}^{C}^{₁}T≈_{C}_{₂}^{A}T

_{C}_{₁}^{A}T(_{C}_{₁}^{M}^{₂}Tₖ)⁻¹ _{C}_{₂}^{M}^{₂}Tₖ≈_{C}_{₂}^{A}T (19)

Same as per the previous embodiments, the calibration information is stored using a matrix, and the following formulas are used to calculate the translation and rotation values of the transformation _{C}_{₂}^{A}T.

$$\begin{matrix}{X}_{6 \times {n}_{r}}^{A {C}_{2}} = [ \begin{matrix}{x}_{0} & {y}_{0} & {z}_{0} & {ϕ}_{0} & {θ}_{0} & {ψ}_{0} \\ ⋮ & ⋮ & ⋮ & ⋮ & ⋮ & ⋮ \\ {x}_{j} & {y}_{0} & {z}_{j} & {ϕ}_{j} & {θ}_{j} & {ψ}_{j} \\ ⋮ & ⋮ & ⋮ & ⋮ & ⋮ & ⋮ \\ {x}_{{n}_{r}} & {y}_{0} & {z}_{{n}_{r}} & {ϕ}_{{n}_{r}} & {θ}_{{n}_{r}} & {ψ}_{{n}_{r}}\end{matrix} ] & ( 20 ) \\ \begin{matrix}{}_{A}^{{C}_{2}} \overline{x} = \frac{1}{{n}_{r}} {\sum }_{i = 1}^{{n}_{r}} {X}_{6 \times i}^{A {C}_{2}} ( 1 ) & {}_{A}^{{C}_{2}} \overline{y} = \frac{1}{{n}_{r}} {\sum }_{i = 1}^{{n}_{r}} {X}_{6 \times i}^{A {C}_{2}} ( 2 ) & {}_{A}^{{C}_{2}} \overline{z} = \frac{1}{{n}_{r}} {\sum }_{i = 1}^{{n}_{r}} {X}_{6 \times i}^{A {C}_{2}} ( 3 )\end{matrix} & ( 21 ) \\ {}_{A}^{{C}_{2}} \overline{ϕ} = atan 2 ( {\sum }_{i = 1}^{{n}_{r}} sin ( {X}_{6 \times i}^{A {C}_{2}} ( 4 ) ) / {\sum }_{i = 1}^{{n}_{r}} cos ( {X}_{6 \times i}^{A {C}_{2}} ( 4 ) ) ) \\ {}_{A}^{{C}_{2}} \overline{θ} = atan 2 ( {\sum }_{i = 1}^{{n}_{r}} sin ( {X}_{6 \times i}^{A {C}_{2}} ( 5 ) ) / {\sum }_{i = 1}^{{n}_{r}} cos ( {X}_{6 \times i}^{A {C}_{2}} ( 5 ) ) ) \\ {}_{A}^{{C}_{2}} \overline{ψ} = atan 2 ( {\sum }_{i = 1}^{{n}_{r}} sin ( {X}_{6 \times i}^{A {C}_{2}} ( 6 ) ) / {\sum }_{i = 1}^{{n}_{r}} cos ( {X}_{6 \times i}^{A {C}_{2}} ( 6 ) ) ) & ( 22 )\end{matrix}$$

After the positions of the markers with respect to the UGV frame and the position of the second camera with respect to the UAV centre are computed, the UGV centre during the flight can be computed. This ends the calibration phase which has shown how to calculate the relative rotation and transformations between the cameras and the markers using the algorithm outlined in Table 3.

During the flight phase, another embodiment of a marker connector module is used for fusing the information from the marker measurements to continuously generate pose information as reference input for the UAV flight controller to estimate the centre of the UGV during take-off, flight and landing. Again fusing comprises combining the data, such as by averaging, included weighted averaging. Fusing may also comprise assessing the quality or confidence of each estimate and choosing one of the two or more estimates available based on the estimate with the greatest confidence.

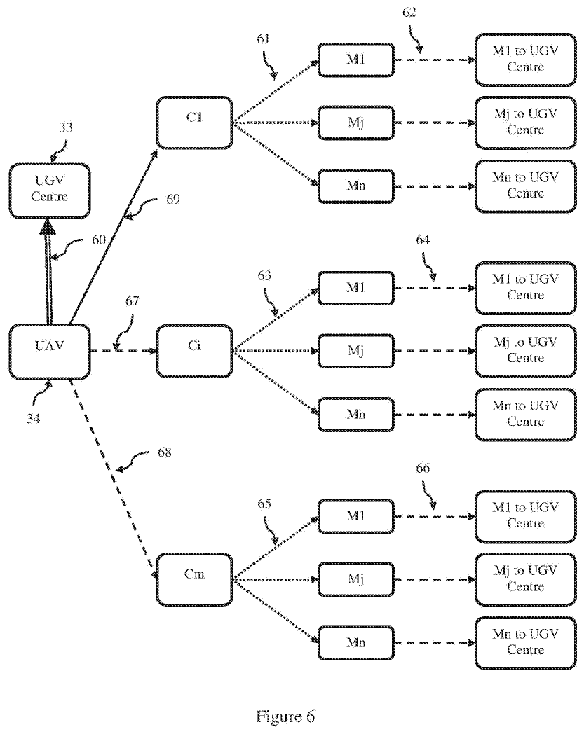

FIG. 6 is modelled on FIG. 5 and is a schematic diagram of the known, observed and generated/estimated transformations between the UGV coordinate frame and UAV coordinate frame for the second calibration method. Like FIG. 5, the solid lines represent the fixed transformations. The black line is the prior information obtained from the 3D model of the system. The dashed lines 62, 64, 66, 67 and 68 are representing the transformations computed during the landing calibration. The dotted lines 61, 63, and 65 are the measurements of the markers from each camera, and finally the black double-line 60 represents the merging of the m×n measurements to a single measurement at all times (ie the data fusion step).

In this embodiment, unlike the first embodiment, the relative position of the cameras is computed. The main motivation behind this decision is to handle physical imperfections and errors in the mounting. Indeed, small angular deviations were observed during the mounting process with the previous method, leading to a lousy estimation of the UGV centre, especially when the height increases. The second major advantage of this method is that all the markers can be observed in the image frame. This reduces the noise during the periods where one marker is at the boundary of the detection range. The third advantage of this method is that the markers are given weights, which in one embodiment is with respect to the perimeter size. This helps to smooth the combined measurements in the cases where the marker is close to getting lost or detection starts when the camera is getting near to the marker.

Again, 6×1 vector and 4×4 transformation notation are used interchangeably. Unlike the previous section where there were only two possible paths between the UAV and the UGV, there are now m×n possible paths. The \vec{P}ₖ^{AC}^{ᵢ}^{M}^{ⱼ}^{G} contains the same information of the combined transformation of _{A}^{G} Tₖ=_{M}^{G}T _{C}_{ᵢ}^{M}^{ⱼ}T_{k A}^{C}^{ᵢ}T, which is the transformation from the UAV frame to the UGV centre through the observation of i-th camera of j-th marker. The first three elements of such vector are for the translation x, y, z, and the last three are for the orientation, ϕ, θ, ψ, measured between [−π, π].

$${{P}^{->}}_{k}^{A {C}_{𝔦} {M}_{j} G} = {[ \begin{matrix}{}_{A}^{{C}_{i} {M}_{j} G}{x}{}_{k}^{} & {}_{A}^{{C}_{i} {M}_{j} G}{y}{}_{k}^{} & {}_{A}^{{C}_{i} {M}_{j} G} z & {}_{A}^{{C}_{i} {M}_{j} G}{ϕ}{}_{k}^{} & {}_{A}^{{C}_{i} {M}_{j} G}{θ}{}_{k}^{} & {}_{A}^{{C}_{i} {M}_{j} G}{ψ}{}_{k}^{}\end{matrix} ]}^{T} \qquad ( 23 )$$

During the flight, all the markers cannot be observed at all times. The following binary function is used to represent observability and stored in a m×n matrix, where each column contains the observed markers by i-th camera.

$${A}_{m \times n} ( i , j ) = \{ \begin{matrix}1 , & \text{if measurement is available} \\ 0 , & \text{else}\end{matrix} \qquad ( 24 )$$

The effect of the marker size was discussed previously. The larger markers provide accurate measurements compared to small markers. We use the following product of two sigmoid functions to create weights for each marker detected. The following function shows the trust we have in the camera pose measurements of each marker.

$$f ( x ( i , j ) , i ) = \frac{1}{( 1 + {e}^{- {a}_{i} ( x ( i , j ) - {b}_{i} )} ) ( 1 + {e}^{- {c}_{i} ( x ( i , j ) - {d}_{i} )} )} \qquad ( 25 )$$

where x(i,j) is the perimeter of j-th marker from the i-th camera. aᵢ and cᵢ are the slope of sigmoid function. The absolute value of cᵢ is higher than the aᵢ, and they are of opposite signs. The trust given to a marker slowly decreases as the size of the marker decrease. For the large markers, the trust in measurement decreases sharply when the marker width starts cover the large portion of the width of the image, where detection can be lost easily due to camera motion. bᵢ and dᵢ the weights become half of the maximum value for left and right tail respectively. These four constants are specific to the vision system, lens and camera. The image size and field of view directly affect these coefficients. More generally the weights may be calculated using a continuous or non-continuous function.

To calculate the transformation between the UAV and the UGV centre \vec{M}ₖ, all the available transformations in the current time frame and observed from multiple cameras and markers are summed up with weights as mentioned earlier.

$${\vec{M}}_{k} ( 1 ) = \frac{{\sum }_{i = 1}^{m} {\sum }_{j = 1}^{n} {A}_{m \times n} ( i , j ) * f ( x ( i , j ) , i ) * {\vec{P}}_{k}^{A {C}_{i} {M}_{j} G} ( 1 ) )}{{\sum }_{i = 1}^{m} {\sum }_{j = 1}^{n} {A}_{m \times n} ( i , j ) * f ( x ( i , j ) , i )} \\ {\vec{M}}_{k} ( 2 ) = \frac{{\sum }_{i = 1}^{m} {\sum }_{j = 1}^{n} {A}_{m \times n} ( i , j ) * f ( x ( i , j ) , i ) * {\vec{P}}_{k}^{A {C}_{i} {M}_{j} G} ( 2 ) )}{{\sum }_{i = 1}^{m} {\sum }_{j = 1}^{n} {A}_{m \times n} ( i , j ) * f ( x ( i , j ) , i )} \\ {\vec{M}}_{k} ( 3 ) = \frac{{\sum }_{i = 1}^{m} {\sum }_{j = 1}^{n} {A}_{m \times n} ( i , j ) * f ( x ( i , j ) , i ) * {\vec{P}}_{k}^{A {C}_{i} {M}_{j} G} ( 3 ) )}{{\sum }_{i = 1}^{m} {\sum }_{j = 1}^{n} {A}_{m \times n} ( i , j ) * f ( x ( i , j ) , i )} \qquad ( 26 )$$

To calculate the combined measurement of m×n angular measurements, the following formula is utilised separately for each ϕ, θ and ψ value:

$${\vec{M}}_{k} ( 4 ) = atan 2 ( \frac{{\sum }_{i = 1}^{m} {\sum }_{j = 1}^{n} sin ( {A}_{m \times n} ( i , j ) * f ( x ( i , j ) , i ) * {\vec{P}}_{k}^{A {C}_{i} {M}_{j} G} ( 4 ) )}{{\sum }_{i = 1}^{m} {\sum }_{j = 1}^{n} cos ( {A}_{m \times n} ( i , j ) * f ( x ( i , j ) , i ) * {\vec{P}}_{k}^{A {C}_{i} {M}_{j} G} ( 4 ) )} ) \\ {\vec{M}}_{k} ( 5 ) = atan 2 ( \frac{{\sum }_{i = 1}^{m} {\sum }_{j = 1}^{n} sin ( {A}_{m \times n} ( i , j ) * f ( x ( i , j ) , i ) * {\vec{P}}_{k}^{A {C}_{i} {M}_{j} G} ( 5 ) )}{{\sum }_{i = 1}^{m} {\sum }_{j = 1}^{n} cos ( {A}_{m \times n} ( i , j ) * f ( x ( i , j ) , i ) * {\vec{P}}_{k}^{A {C}_{i} {M}_{j} G} ( 5 ) )} ) \\ {\vec{M}}_{k} ( 6 ) = atan 2 ( \frac{{\sum }_{i = 1}^{m} {\sum }_{j = 1}^{n} sin ( {A}_{m \times n} ( i , j ) * f ( x ( i , j ) , i ) * {\vec{P}}_{k}^{A {C}_{i} {M}_{j} G} ( 6 ) )}{{\sum }_{i = 1}^{m} {\sum }_{j = 1}^{n} cos ( {A}_{m \times n} ( i , j ) * f ( x ( i , j ) , i ) * {\vec{P}}_{k}^{A {C}_{i} {M}_{j} G} ( 6 ) )} ) \qquad ( 27 )$$

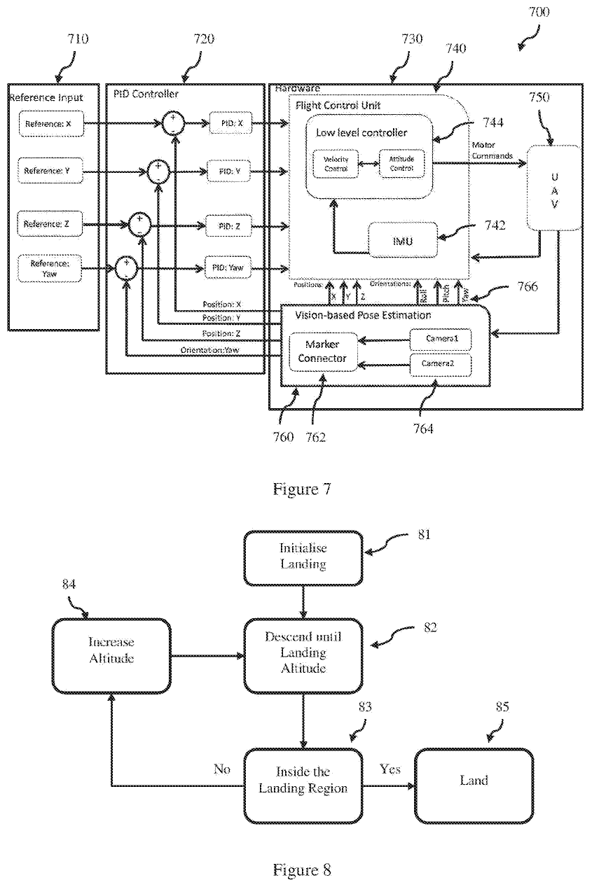

The embodiments described above may be implemented by a processor and associated memory incorporated on an UAV platform further comprising a flight controller (and two cameras). FIG. 7 is a schematic block diagram of the control architecture 70 of a UAV according to an embodiment. In this embodiment the flight controller 740 is a two-level controller. The high-level controller generates velocity commands using the combined pose measurement 766 from the cameras 764 provided by pose estimation module 760, implementing the marker connector 762 module to fuse pose estimates from multiple camera 764. The low-level controller 744 converts the velocity commands first to attitude and then to PWM values (motor commands) for the ESCs 750. In one embodiment a simple Kalman Filter was applied on the flight controller side to smoothen the pose estimation. The ψ,θ stabilisation is done on the low-level controller with the help of IMU measurements 742. The velocity commands are generated for x,y,z and ψ using the position information computed using computer vision. The user gives reference input 710 such as height and yaw reference commands. The reference for x and y are always zero. The velocity commands are calculated by a simple PID controller 720 using the Equation 28 and the Equation 29.

$$\begin{matrix}{e}_{x} ( t ) = - {\vec{M}}_{k} ( 1 ) \\ {e}_{y} ( t ) = - {\vec{M}}_{k} ( 2 ) \\ {e}_{z} ( t ) = {z}_{r e f} - {\vec{M}}_{k} ( 3 ) \\ {e}_{ψ} ( c ) = {ψ}_{r e f} - {\vec{M}}_{k} ( 6 ) & ( 28 ) \\ {u}_{x} ( t ) = {K}_{p , x} {e}_{x} ( t ) + {K}_{i , x} {\int }_{0}^{t} {e}_{x} ( τ ) d τ + {K}_{d , x} \frac{d}{dt} {e}_{x} ( t ) \\ {u}_{y} ( t ) = {K}_{p , y} {e}_{y} ( t ) + {K}_{i , y} {\int }_{0}^{t} {e}_{y} ( τ ) d τ + {K}_{d , y} \frac{d}{dt} {e}_{y} ( t ) \\ {u}_{z} ( t ) = {K}_{p , z} {e}_{z} ( t ) + {K}_{i , z} {\int }_{0}^{t} {e}_{z} ( τ ) d τ + {K}_{d , z} \frac{d}{dt} {e}_{z} ( t ) \\ {u}_{ψ} ( t ) = {K}_{p , ψ} {e}_{ψ} ( t ) + {K}_{i , ψ} {\int }_{0}^{t} {e}_{ψ} ( τ ) d τ + {K}_{d , ψ} \frac{d}{dt} {e}_{ψ} ( t ) & ( 29 )\end{matrix}$$

The controller handles all aspects of the flight including take-off, landing and the following. Take-off and following are straightforward, but a sub-routine is added to increase the precision during landing. The two main reasons for this sub-routine are the ground effect, with the turbulent airflow effect coming back from the ground as the UAV descends, and the marker not being at the correct position calculated from the landing calibration. FIG. 8 is a flowchart of a landing process according to an embodiment. The landing process is initiated when the UGV is stationary 81. After the land command is sent, the UAV ascends to a specific predefined height, H_{LC}, and starts checking if the Equation 30 is true.

e_{L}(t)=eₓ(t)+e_{y}(t)<τ_{L} (30)

If the e_{L}(t) is within the threshold τ_{L}, the system proceeds with the landing, slowly decreasing the altitude 82. The check (ie inside the landing region) is done at every control iteration 83 until the UAV lands 85. For the cases where e_{L}(t) becomes larger than the threshold, the UAV ascends to a height where the Equation 30 becomes true again 84. The ascend-descend process is repeated as many times as necessary. It is important to note that the ascend-descend cycle has not been observed more than a couple of times.

In one embodiment a custom-built UAV hexacopter was constructed using a Hexa-X motor configuration. The UAV was equipped with an on-board computer. A flight controller module with IMU was connected. The flight controller is capable of fusing and filtering multiple sensors as well as external velocity and position commands to generate output for motors.

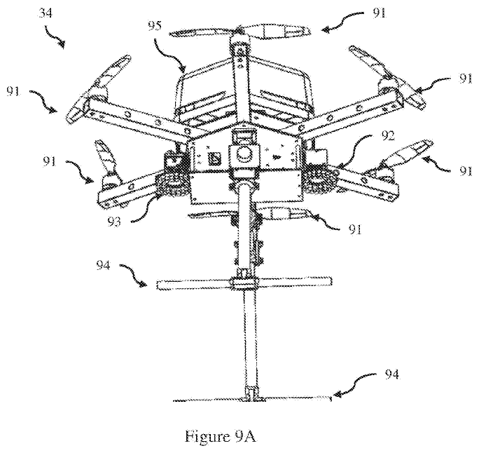

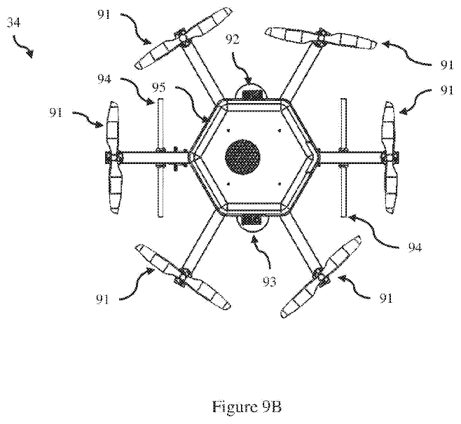

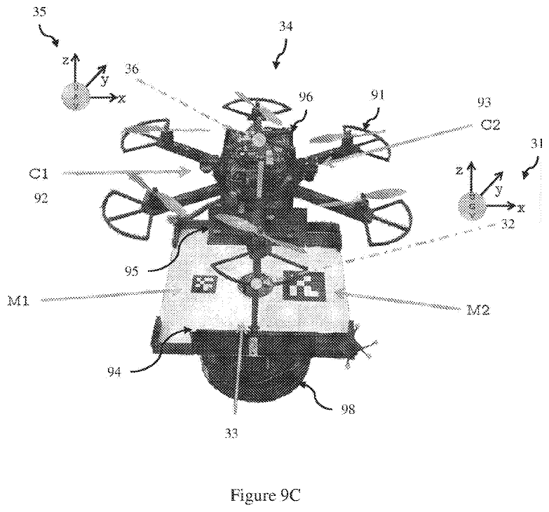

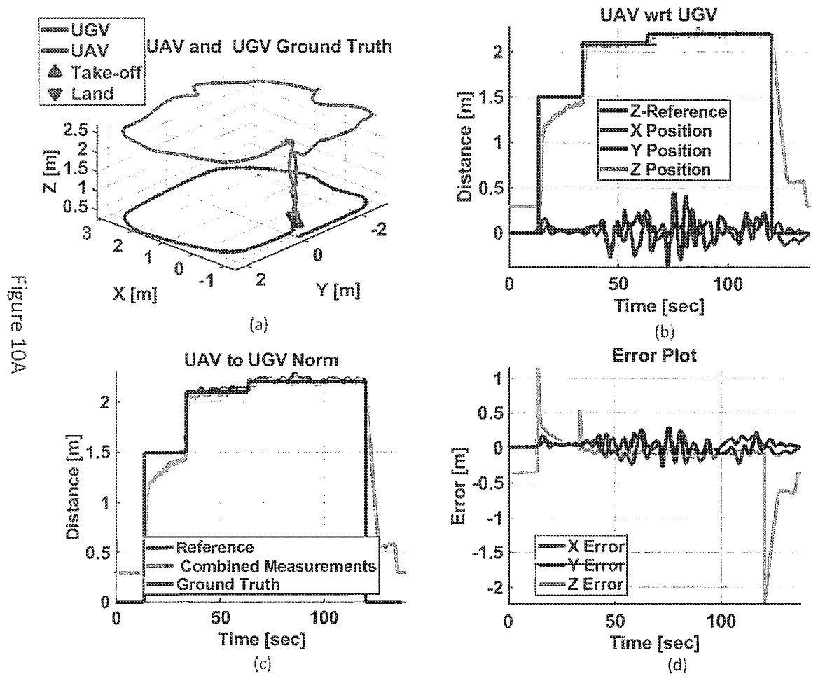

There are two cameras mounted on the UAV, and both are mounted down-looking. These cameras are designated CamFar and CamNear with respect to the lenses mounted on each. The onboard computer executed a Robot Operating System (ROS) on Ubuntu Linux 16.04. All the processing is done on-hoard, and the system is remotely accessed to issue take-off, change the height and land commands, as well as recording data via rosbags. The system can employ other sensors such as Sonar, Laser, Lidar (Light, Detection and Ranging device), UWB (Ultra Wide Band), etc. with sensor fusion to increase accuracy and add extra functionality. FIG. 9A shows a side profile and FIG. 9B shows a top profile of the UAV 34. In this embodiment the UAV comprises six sets of propellers 91 a first camera 92, a second camera 93, a pair of landing legs 94 and a central platform 95 which houses the onboard computer and flight controller 96 and in which other devices (eg LIDAR) may be mounted. In this embodiment the cameras are surrounded by lights (illumination sources for the markers). FIG. 9C is a perspective view of the UAV 34 landed on the UGV 98.

The ground robot with the landing platform is a TurtleBot2 98 equipped with a laptop. The laptop is only used for remote control and teleoperation of the UGV with a joystick. Again a ROS was used to teleoperate and move the UGV. The landing platform is a 50×50 cm aluminium composite panel with custom 3D-printed guiding tracks to guide the UAV passively during the landing. The drone 34 on the Turtlebot2 98 can be seen in the FIG. 9C which also shows the landing pad 33. The central hole can be used for connecting a power tether for long duration flights. The landing platform has guiding tracks to help the UAV increase the accuracy of the landing.

The above process is for landing while the primary system is fully functional. Two alternative ways that can be used for emergency landing as a secondary landing method. In the first embodiment, multiple UWB anchors are installed on the landing platform and ground robot to do coarse localization. In case of emergency, this method uses emergency landing with the help of secondary or primary IMU and information provided by AGV. In the second embodiment a tether is employed, which can be used to land the drone on the landing platform forcefully. In case of an emergency, the tether system attached to the drone and AGV starts pulling the UAV down with larger force. The UAV will also use its full throttle to go up and secondary or primary IMU to level itself. The tether systems pull stronger than the maximum possible thrust of our UAV. As the two opposing forces balance each other out the UAV will end up at hovering and then will start to land slowly. When the motors touch, the landing platform motors will stop immediately.

A series of experimental tests were conducted to test both calibration methods. The flight tests start with the UAV on the UGV. The user gives only the take-off and land commands to the UAV, and the rest is fully autonomous. The UGV is operated with a joystick inside an arena covered with Optitrack cameras. Optitrack is a product of Naturalpoint, infrared cameras used for tracking infrared markers with millimetre level of accuracy. The Optitrack system composed of nine cameras, mounted at 3.8 m height was used to track the UAV and UGV. The arena is 8 m×8 m with 4.5 m height. In general, such systems are capable of sub-millimetre accuracy depending on the positioning, calibration and markers on the target.

The second test is called the range tests. The drone is not able to fly more than three and a half meters as absolute height, due to the physical limitations of the laboratory and tracking system. The range, up to three-meter height, can be covered with a single camera. To show the validity of using multiple cameras a range test is conducted in the same manner as the previous performance evaluations for detectors and markers. This time, one robot is placed on a table, either the UAV or the UGV, and the other robot is carried away, starting from landing position and brought back to landing position. During this experiment, the cameras are always pointed towards the marker.

For these experiments, six different bodies are followed and recorded by the Optitrack system, which are UAV, UGV, CamNear (C1), CamFar (C2), Marker1 identified with Tag0 and Marker2 identified with Tag1. The ROS package mocap_optitrack is executed on the UAV to record the pose information. Optitrack measurements are acquired in the Optitrack frame, and the markers are detected in the respective camera frames. To be able to convert the measurements from the camera frame to the Optitrack frame, the accurate pose information of each camera is required. During the experiments, it has been noticed that plotting the x, y, and z values of the camera measurement in the Optitrack frame is not straightforward, mainly due to small angular errors. It was decided to use norm values in the figures below to compare the Optitrack and Camera measurements. The norm values are chosen for their invariance to rotation. Another advantage is that the UAV is following the UGV by trying to keep x and y as zero, as a consequence the contribution of x and y is the error, making the norm value as an easy way to analyse metric. In the tests of the first embodiment in which both cameras view markers when landed, the smaller marker had a size of 7.1 cm and the second larger marker had a size of 11.7 cm In the tests of the second embodiment, where only the first camera is required to view a marker when landed, the first smaller marker had a size of a size of 7.1 cm and the second larger marker had a much larger size of 22.8 cm.

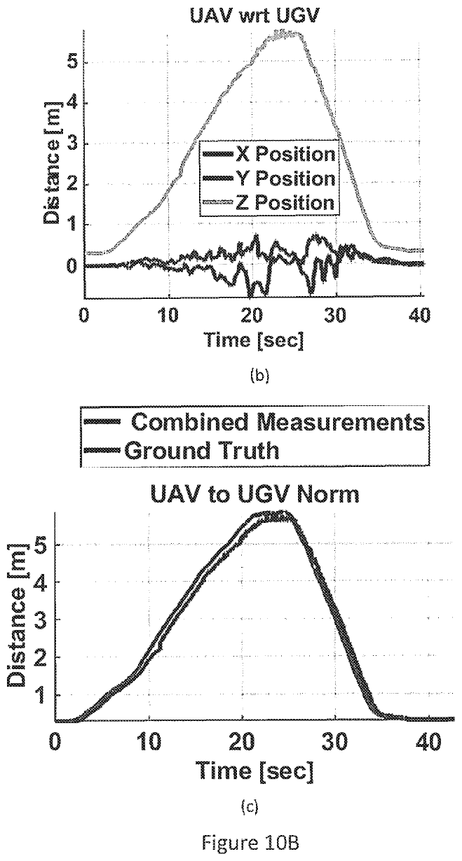

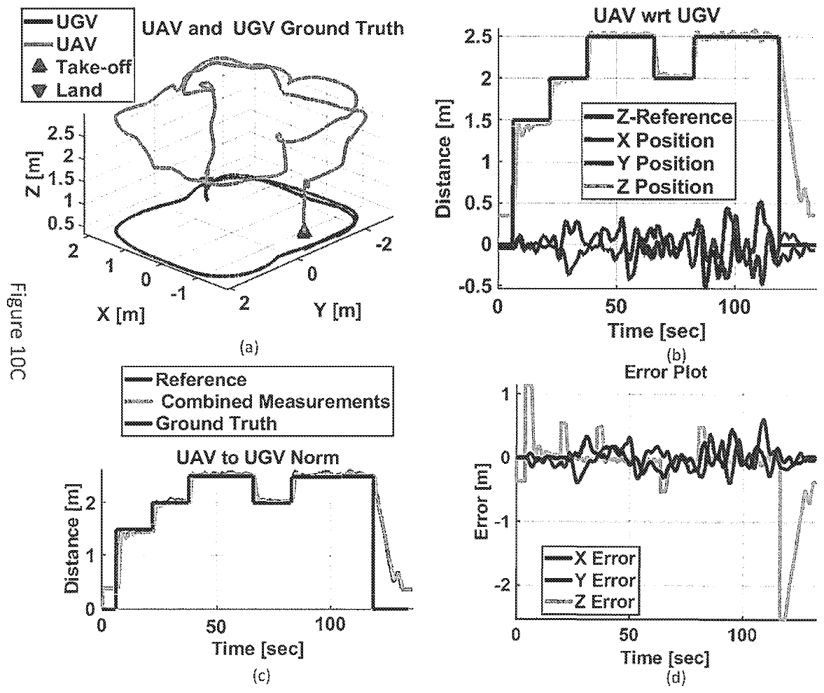

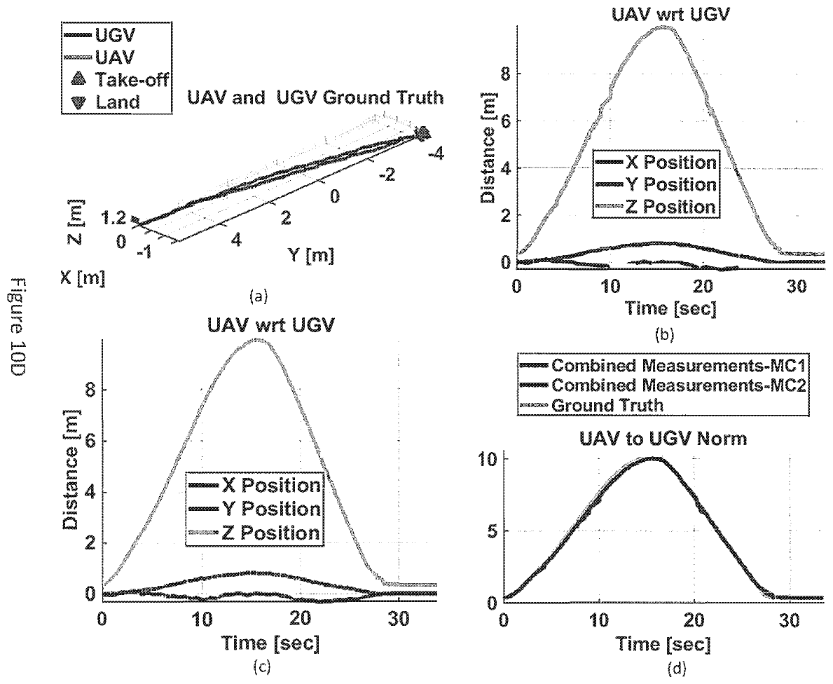

FIG. 10A is a panel of plots of a flight test using the first embodiment, and FIG. 10B is a panel of plots of a range test using the first embodiment. Similarly FIG. 10C is a panel of plots of a flight test using the second embodiment, and FIG. 10D is a panel of plots of a range test using the second embodiment.

FIG. 10A is a panel of plots of a flight test using the first embodiment. Panel (a) is a 3D plot of the UAV and the UGV, panel (b) is the position of the UAV with respect to the UGV during the flight, panel (c) is the norm of distance of the UAV from the UGV with ground-truth and reference, and panel (d) is the position error of the UAV during the flight. These plots show the first embodiment is accurately able to estimate the pose (ie position) of the UAV and thus track the position of the UGV (and control the flight of the UAV). At the end of the flight test experiment for the first embodiment, the landing is observed with an error position of 1.23 cm on the y-axis and −0.32 cm on the x-axis, this minor error is mostly due to the guidance provided by the landing platform. This experiment has been conducted more than two hundred times during months in various indoor environments: labs, auditorium, warehouses. Several consecutive take-off and landings have been done without any adjustment required. The error was significant only when there were magnetic interferences or at cases where illumination is problematic.

FIG. 10B is a panel of plots of a range test using the first embodiment. Panel (a) is a 3D plot of the UAV and the UGV, panel (b) is the position of the UAV with respect to the UGV during the experiment, and panel (c) is the norm of distance of the UAV from the UGV (ie the combined measurements) with ground-truth. These plots show the system was accurately able to track the markers up to a height of 5.7 m. The first far camera was able to track the first marker from ground to around 5.7 m, and the second near cam was able to track the second marker from ground to around 2 m. Thus in this embodiment combined measurements are used up to around 2 m, and then the system switches to just using pose estimates from the far camera.

Similarly FIG. 10C is a panel of plots of a flight test using the second embodiment. Panel (a) is a 3D plot of the UAV and the UGV, panel (b) is the position of the UAV with respect to the UGV during the flight, panel (c) is the norm of distance of the UAV from the UGV with ground-truth and reference, and panel (d) is the position error of the UAV during the flight. These plots show the first embodiment is accurately able to estimate the pose (ie position) of the UAV and thus track the position of the UGV (and control the flight of the UAV). Similar to the results obtained with the first algorithm, an accurate landing is achieved with the second algorithm, the positioning error being 3.07 cm on the x-axis and −2.93 cm on the y-axis. Using this algorithm, the UAV flies up to a higher altitude than the first method, but the landings with the second method are slightly less accurate than with the first method.

FIG. 10D is a panel of plots of a range test using the second embodiment. Panel (a) is a 3D plot of the UAV and UGV, panel (b) is the combined pose measurement from first marker connector of the UAV with respect to UGV during the experiment, panel (c) is the combined pose measurement from the second marker connector of the UAV with respect to UGV during the experiment, and panel (d) is the norm of the distance of the UAV from the UGV from the marker connectors with ground-truth. These plots show the system was accurately able to track the markers up to a height of 10 m, showing the extended range performance of the second embodiment. The plots also show the redundancy and the ability to obtain multiple pose estimates from the different cameras which can then be fused together. The near camera was able to track the first marker from 1 m to around 6.75 m and the second smaller marker from ground to around 2 m. The far cam was able to track the first marker from 1 m to 10 m, and the second smaller marker from 1 m to around 6.75 m. The weights were also evaluated and performed as expected.

Embodiments of a UAV system for that can take-off, navigate and land safely back on a UGV in a GPS-denied environment have been described. The methods involve a calibration phase, and once complete, the measurements from each monocular camera system are fused to generate reference input for the UAV flight controller (the fusing is performed by a Marker Connector module executing on an onboard computer).

The cameras implement computer vision techniques to detect geometrical properties of markers, and then apply homographic techniques to obtain distance and pose estimates. Testing was performed using several marker detector libraries and different marker (tag) families. Using a single-core of a multi-threaded computer, an Aruco3 detector was fastest while the Apriltag2 detector can detect the smallest tags, meaning it has the most extended detection range among the three tested. Range testing for successful detection and pose extraction suggested the marker perimeter could be used as a geometrical indicator for accurate pose measurements. The distance between the marker and the 3D position error was been proportional. It is also noticed that the marker families with smaller bits numbers have better detection range.

Embodiments of the method include a calibration phase and a flight phase. The purpose of the calibration of cameras is to “teach” the cameras to obtain the right distance measurement from the markers, and the X,Y coordinates in a 3D space. Since the distance between the markers, the size of markers are known and fixed, we can vary and measure the distance of the marker to the camera and obtain the camera pixel information to “train and teach” the camera to be able to obtain distance measurement just by looking at the marker. When calibrating a multi cameras, we can also take note of the additional information, distance between the cameras, to give us more information to make the pose estimation more accurate.

The method of calibration for multiple cameras is different from the calibrating of single cameras or duplicate cameras as more information can be obtained from the additional relationships between the cameras. In the second embodiment relative pose estimation between cameras is performed. This process is similar to stereo camera calibration, but in this embodiment we are estimating the relative distance between two cameras. The main difference with stereo camera calibration is the use of lenses with different focus, which increases the complexity of the calibration process. Using cameras/lenses with different focal length is a significant difference with prior art. Another significant difference is for stereo camera calibration two cameras need to be tightly synchronized, while the present system can work with or without hardware synchronization. This embodiment also involves relative pose estimation between markers. This information can be used for the cases where the cameras cannot see multiple markers.

Two detailed embodiments have been discussed for a UAV to take-off, land and track a moving platform, including two calibration methods for marker-based localisation using a dual camera setup. In the first embodiment each marker is visible to one camera when landed. During flight each cameras detect their respective markers and the pose estimates are fused. The marker connector module performs the data fusing and can combine measurements from two cameras or use measurements from a single camera at high altitude, when the smaller marker is no longer visible. This method enabled to achieve successful landing and tracking, but the assumption of both markers being visible limits the vertical range of the UAV. The second method is a generalised version of the first and allows more adaptability and extended range/performance. This method is also applicable for n cameras and m markers, where m≥n≥2, and is adapted to handle any number of measurements between 1 and m*n. In the landing state only one camera is required to observe one marker, and as the UAV ascends measurements from multiple markers in the field of view of each camera are used for generating a combined measurement. The first method has better accuracy during landing and the second method has better tracking performance and a more extended range.

Whilst the above embodiments describe a two camera system, the UAV may be fitted with additional cameras, each having a longer focal length, to extend the range. The UAV may use a first or first and second camera during take-off and landing (low height rang), and then switch to the third camera for a medium height range, and then switch to the fourth camera for high height range. The UAV controller ensures that the UAV stays at a height such that at least one marker is viewed (or viewable) at all times. Data fusion which may be implemented by the marker connector module or the UAV controller, may comprise combining the data, such as by averaging, included weighted averaging or may involve selecting one estimate from multiple estimates based on assessing the quality or confidence of each estimate. In this case fusing comprises choosing one of the two or more estimates available based on the estimate with the greatest confidence. Fusing may also comprise switching from one camera to another camera based on a quality assessment or other data. For example as the UAV ascends, or as the vehicle the landing surface is on moves, the appearance of the marker may change due to a change in lighting or illumination, affecting the ability to identify the marker and estimate the geometrical property. Thus a pose estimate may also include generating a confidence or quality assessment which is then used in the fusing step to make a decision on which camera, or which camera/marker pair to use.

Those of skill in the art would understand that information and signals may be represented using any of a variety of technologies and techniques. For example, data, instructions, commands, information, signals, bits, symbols, and chips may be referenced throughout the above description may be represented by voltages, currents, electromagnetic waves, magnetic fields or particles, optical fields or particles, or any combination thereof.

Those of skill in the art would further appreciate that the various illustrative logical blocks, modules, circuits, and algorithm steps described in connection with the embodiments disclosed herein may be implemented as electronic hardware, computer software or instructions, middleware, platforms, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The steps of a method or algorithm described in connection with the embodiments disclosed herein may be embodied directly in hardware, in a software module executed by a processor, or in a combination of the two, including cloud based systems. For a hardware implementation, processing may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, or other electronic units designed to perform the functions described herein, or a combination thereof. Various middleware and computing platforms may be used.

Various embodiments, modules and components of the system described herein may comprise one or more computing (or processing) apparatus each comprising at least one processor and a memory operatively connected to the processor, and is configured to perform all or some of the steps of the method described herein. In some embodiments the computing apparatus comprises one or more Central Processing Units (CPUs) configured to perform some of the steps of the methods. A computing apparatus may comprise one or more CPUs. A CPU may comprise an Input/Output Interface, an Arithmetic and Logic Unit (ALU) and a Control Unit and Program Counter element which is in communication with input and output devices through the Input/Output Interface. The Input/Output Interface may comprise a network interface and/or communications module for communicating with an equivalent communications module in another device using a predefined communications protocol (e.g. Bluetooth, Zigbee, IEEE 802.15, IEEE 802.11, TCP/IP, UDP, etc). The computing apparatus may comprise a single CPU (core) or multiple CPU's (multiple core), or multiple processors. The computing apparatus may use a parallel processor, a vector processor, or graphical processing units (GPUs). Memory is operatively coupled to the processor(s) and may comprise RAM and ROM components, and may be provided within or external to the device or processor module. The memory may be used to store an operating system and additional software modules or instructions. The processor(s) may be configured to load and executed the software modules or instructions stored in the memory. In some embodiments the computing apparatus may be a ruggedized computing apparatus and/or an integrated realtime system configured to supporting processing on a UAV platform. Further the computing (or processing) apparatus may be designed as a low power, mobile computing system with integrated processing and communications modules.

Software modules, also known as computer programs, computer codes, or instructions, may contain a number a number of source code or object code segments or instructions, and may reside in any computer readable medium such as a RAM memory, flash memory, ROM memory, EPROM memory, registers, hard disk, a removable disk, a CD-ROM, a DVD-ROM, a Blu-ray disc, or any other form of computer readable medium. In some aspects the computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media. In another aspect, the computer readable medium may be integral to the processor. The processor and the computer readable medium may reside in an ASIC or related device. The software codes may be stored in a memory unit and the processor may be configured to execute them. The memory unit may be implemented within the processor or external to the processor, in which case it can be communicatively coupled to the processor via various means as is known in the art.

Further, it should be appreciated that modules and/or other appropriate means for performing the methods and techniques described herein can be downloaded and/or otherwise obtained by computing device. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a computing device can obtain the various methods upon coupling or providing the storage means to the device. Moreover, any other suitable technique for providing the methods and techniques described herein to a device can be utilized.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement of any form of suggestion that such prior art forms part of the common general knowledge.

It will be appreciated by those skilled in the art that the disclosure is not restricted in its use to the particular application or applications described. Neither is the present disclosure restricted in its preferred embodiment with regard to the particular elements and/or features described or depicted herein. It will be appreciated that the disclosure is not limited to the embodiment or embodiments disclosed, but is capable of numerous rearrangements, modifications and substitutions without departing from the scope as set forth and defined by the following claims.

What is claimed is:

1. A method for tracking the location of a first reference point of a landing surface by an unmanned aerial vehicle (UAV) comprising at least two cameras wherein at least the second camera has a different focal length to the first camera and a flight controller comprising at least one inertial measurement unit (IMU), wherein the landing surface comprises at least two markers, the method comprising:
during a calibration phase:
storing at least one geometrical property of each of the at least two markers;
capturing at least a first calibration image containing a least a first marker by a first camera, and capturing at least a second calibration image containing at least a second marker by a second camera wherein at least the second camera has a different focal length to the first camera; and
estimating the pose of each marker with respect to the first reference point is performed using at least one estimated geometrical property of the marker and the stored at least one geometrical property of the marker; and
obtaining, either directly or indirectly, a pose of each camera with respect to a second reference point on the UAV;
storing calibration data comprising at least the pose of each of the at least two markers with respect to the first reference point and a pose of each camera with respect to a second reference point on the UAV;
and during a flight phase:
capturing at least one image containing at least one of the markers by at least one camera;
generating one or more pose estimates for each of the at least one camera comprising:
for each captured image and for at least one of the markers in the captured image,
estimating a pose of the camera that captured the image with respect to one of the at least one markers in the image using an estimate of at least one geometrical property of the respective marker in the captured image and the stored at least one geometrical property of the respective marker;
estimating the pose of the UAV with respect to the first reference point by fusing the one or more pose estimates for each of the at least one camera using the calibration data;
providing the estimate of the pose of the UAV as input to the flight controller of the UAV for tracking the location of the first reference point.

2. The method as claimed in claim 1, wherein at least one marker has larger size than at least one other marker.

3. The method as claimed in claim 1 or 2, wherein during the flight phase fusing comprises averaging the one or more pose estimates.

4. The method as claimed in claim 4, wherein during the flight phase fusing comprises selecting one of the one or more pose estimates.

5. The method as claimed in any one of claims 1 to 4, wherein during the flight phase capturing at least one image containing at least one of the markers by at least one camera comprises capturing one or both of:
at least a first image containing the first marker by the first camera, and
at least a second image containing at least the second marker by the second camera;
and generating one or more pose estimates comprises estimating, when the at least a first image is captured, at least a first pose of the first camera with respect to the first marker using an estimate of at least one geometrical property of the first marker in the first image and the stored at least one geometrical property of the first marker, and, when the at least a second image is captured, at least a second pose of the second camera with respect to the second marker using an estimate of at least one geometrical property of the second marker in the second image and the stored at least one geometrical property of the second marker;
and estimating the pose of the UAV comprises estimating the pose of the UAV with respect to the first reference point by fusing the first pose estimate of the first camera and the second pose estimate of the second camera using the calibration data.

6. The method as claimed in any one of claims 1 to 4, wherein during the calibration phase, the capturing step is performed when the UAV is landed on the landing surface, and during a take-off portion or a landing portion of the flight phase, capturing at least one image comprises capturing at least a first image containing the first marker by the first camera and at least a second image containing at least the second marker by the second camera in a first height range, and generating one or more pose estimates for each of the at least one camera comprises generating at least a first pose estimate of the first camera with respect to the first marker and at least a second pose estimate of the second camera with respect to the second marker.

7. The method as claimed in claim 6, wherein the second camera has a longer focal length than the first camera, and a size of the first marker in the first calibration image is less than the smaller of a width dimension and a height dimension of the first calibration image, and a size of the second marker is at least equal to or larger than the size of the first marker.

8. The method as claimed in any one of claims 6 to 7 wherein during the calibration phase a first set of two or more calibration images each containing the first marker are captured by the first camera, and a second set of two or more calibration images each containing the second marker are captured by the second, and the step of estimating at least a first pose of the first camera comprises estimating a first set of poses, wherein each pose in the first set is estimated from the corresponding image in the first set of two or more calibration images, and averaging the poses in the first set to obtain the estimate of the pose of the first marker with respect to the reference point, and estimating a second set of poses, wherein each pose in the second set is estimated from the corresponding image in the second set of two or more calibration images, and averaging the poses in the second set to obtain the estimate of the pose of the second marker with respect to the reference point.

9. The method as claimed in any one of claims 6 to 8, wherein if estimation of at least a first pose of the first camera with respect to the first marker fails, then fusing the first pose estimate of the first camera and the second pose estimate of the second camera comprises using the second pose estimate of the second camera to estimate the pose of the UAV with respect to the reference point.

10. The method as claimed in claim 1 or 2 wherein the step of obtaining calibration data is performed in at least two calibration phases, wherein the first calibration phase is performed when the UAV is landed on the landing surface, and the second phase and any subsequent phases is performed when the UAV is at one or more locations away from the landing surface and second camera has a focal length such that when the UAV is landed on the landing surface at least the first marker is visible to the first camera, and the two or more makers are not required to be visible to the other cameras, and the step of capturing at least a first calibration image containing a least a first marker by a first camera, and capturing at least a second calibration image containing at least a second marker by second camera is performed as part of the second calibration phase, and wherein the first calibration phase comprises:
capturing at least a first calibration image containing the first marker by the first camera; and
estimating the pose of the first marker with respect to the first reference point using at least one estimated geometrical property of the first marker and the stored at least one geometrical property of the first marker; and
obtaining a pose of the first camera with respect to the second reference point;
and the second calibration phase and any subsequent calibration phase comprises:
capturing, by a pair of cameras, at least a first image by one of the cameras containing at least two markers, and at least a second image captured by the other camera in the pair containing at least one of the at least two markers in the first image,
wherein each subsequent phase comprises repeating the capturing step with a new pair of cameras and is performed if there is insufficient images captured to enable a pose estimate of each marker with respect to the first reference point to be estimated and to enable a pose estimate of each camera with respect to second reference point to be estimated, and the UAV may be moved between each phase;
estimating, for each marker other than the first marker, the pose of the marker with respect to the first reference point using at least one estimated geometrical property of the marker and the stored at least one geometrical property of the marker; and
estimating, for each camera other than the first camera, a pose of the camera with respect to the second reference point wherein the estimate is performed indirectly by estimating the pose of the camera with respect to the first camera.

11. The method as claimed in any preceding claim, wherein during the flight phase, generating one or more pose estimates for each of the at least one camera further comprises estimating a camera-marker weight for each marker captured in an image by a camera, and fusing comprises calculating a weighted sum of the one or more pose estimates using the associated camera-marker weights to obtain an estimate of the pose of the UAV with respect to the first reference point.

12. The method as claimed in claim 11, where in a camera-marker weight is based on a size of the marker in the image.

13. The method as claimed in claim 11 or 12, wherein a camera-marker weight is calculated using a continuous or non-continuous function

14. The method as claimed in any preceding claim, wherein the two or more markers are formed of a reflective surface, and the UAV illuminates the landing surface.

15. The method as claimed in any preceding claim wherein the calibration data further comprises one or more transformation matrices for transforming a measurement obtained from an image from a UAV coordinate frame centred on the second reference point to a global coordinate frame centred on the first reference point.

16. An unmanned aerial vehicle (UAV) comprising:
at least two cameras, wherein each camera has a downward field of view with respect to the UAV and wherein at least the second camera has a different focal length to the first camera;
a flight controller comprising at least one inertial measurement unit (IMU);
at least one processor and a memory, the memory comprising instructions to perform the method of any one of claims 1 to 15.

17. A system comprising an unmanned aerial vehicle (UAV) as claimed in claim 16 and a moveable or stationary vehicle comprising a landing surface for the UAV.

18. An unmanned aerial vehicle (UAV) comprising:
at least two cameras, wherein each camera has a downward field of view with respect to the UAV and wherein at least the second camera has a different focal length to the first camera;
a flight controller comprising at least one inertial measurement unit (IMU);
at least one processor and a memory, the memory comprising instructions to tracking the location of a first reference point of a landing surface, wherein the landing surface comprises at least two markers, wherein during a calibration phase the processor is configured to:
store at least one geometrical property of each of the at least two markers;
capture at least a first calibration image containing a least a first marker by a first camera, and capturing at least a second calibration image containing at least a second marker by a second camera; and
estimate the pose of each marker and with respect to the first reference point on the landing surface using at least one estimated geometrical property of each marker and the stored at least one geometrical property of the marker;
obtain, either directly or indirectly, a pose of each camera with respect to a second reference point on the UAV;
store calibration data comprising at least the pose of each of the at least two markers with respect to the first reference point and a pose of each camera with respect to a second reference point on the UAV;
and during a flight phase the processor is configured to:
capture at least one image containing at least one of the markers by at least one camera;
generating one or more pose estimates for each of the at least one cameras comprising:
for each captured image and for at least one of the markers in the captured image, estimating a pose of the camera that captured the image with respect to one of the at least one markers in the image using an estimate of at least one geometrical property of the respective marker in the captured image and the stored at least one geometrical property of the respective marker;
estimate the pose of the UAV with respect to the first reference point by fusing the one or more pose estimates for each of the at least one cameras using the calibration data;
provide the estimate of the pose of the UAV as input to the flight controller of the UAV for tracking the location of the first reference point.
